(19) United States
(12) Patent Application Publication
(10) Pub. No.: US 2023/0176249 A1
(43) Pub. Date: Jun. 8, 2023

(54) Hybrid Lens and Method for Manufacturing Hybrid Lens

(71) Applicant: Daicel Corporation, Osaka (JP)

(72) Inventors: Hiroki Takenaka, Tokyo (JP); Hiromi Honma, Tokyo (JP); Hiroyuki Hanato, Tokyo (JP); Shinji Kikuchi, Tokyo (JP)

(73) Assignee: Daicel Corporation, Osaka (JP)

(21) Appl. No.: 17/987,136

(22) Filed: Nov. 15, 2022

(30) Foreign Application Priority Data
Nov. 16, 2021 (JP) 2021-186644
Nov. 16, 2021 (JP) 2021-186645
Nov. 16, 2021 (JP) 2021-186646

(51) Int. Cl. G02B 1/04; B29D 11/00; C09J 163/00; C09J 133/04; C09J 5/00

(52) U.S. Cl. CPC G02B 1/041; B29D 11/00442; B29D 11/00403; C09J 163/00; C09J 133/04; C09J 5/00; G02B 5/005

(57) ABSTRACT

As a first aspect, provided is a hybrid lens for which peeling and shifting of a glass and a resin lens do not easily occur, and for which floating of an adhesive layer and peeling between the glass and resin lens do not easily occur even when the hybrid lens is exposed to a high temperature environment. As a second aspect, provided is an easily produced hybrid lens in which a glass and a resin lens are laminated, and in which the resin lens and a light-shielding portion are laminated with good precision.

The hybrid lenses 11 and 12 each include a glass substrate 3, a resin lens 2, and an adhesive layer 4 provided between the glass substrate 3 and the resin lens 2. In the hybrid lens 11, the glass transition temperature of the resin lens 2 is higher than the glass transition temperature of the adhesive layer 4, and the difference between the glass transition temperature of the resin lens 2 and the glass transition temperature of the adhesive layer 4 is from 97 to 150° C. The hybrid lens 12 further includes a metal compound layer 52 provided between the glass substrate 3 and the resin lens 2.

### TECHNICAL FIELD

The present disclosure relates to a hybrid lens. More specifically, the present disclosure relates to a hybrid lens including a glass substrate and a resin lens. The present application claims the rights of priority of JP 2021-186644, JP 2021-186645, and JP 2021-186646 filed in Japan on 16 Nov. 2021, the contents of which are incorporated herein.

### BACKGROUND ART

In recent years, hybrid lenses in which glass and a resin lens are laminated have been used as lenses that fully utilize the optical characteristics of both glass and resin lenses. However, since glass and resin lenses are mutually different materials, adhesiveness is low and peeling is likely to occur, unfortunately. Due to low adhesiveness between glass and a resin lens, shifting and peeling of the glass and resin lens may occur when, for example, a lens array laminate obtained by laminating a glass and a lens array is singulated into individual pieces through dicing in an attempt to obtain an individual hybrid lens.

In a known method for improving the adhesiveness between the glass and resin lens, glass and resin lenses are laminated with an adhesive interposed therebetween. For example, Patent Document 1 discloses a specific lens adhesive, and indicates that the lens adhesive exhibits excellent robustness when subjected to ultraviolet radiation, and that an optical lens that uses the adhesive is highly durable.

In addition, as an optical diaphragm (light-shielding portion) of the hybrid lens, electrolytically oxidized black stainless steel or a black resist is generally formed in a non-effective region of the glass or lens. In addition, the light-shielding portion may be applied to individual hybrid lenses in a state of being integrated with a holder.

In a known method for producing the individual hybrid lenses, a lens array laminate (wafer lens laminate) is obtained by laminating a lens array, a light-shielding portion, and a glass substrate and is then singulated through dicing into individual pieces. Here, the lens array has a configuration in which a plurality of lens effective regions are two-dimensionally arranged and these lenses are mutually connected through joining parts. Further, the light-shielding portion is provided with a plurality of light-transmitting portions (openings) according to the effective regions of the lenses. According to such a method, individual hybrid lenses can be more easily manufactured with less variation in quality between the individual lenses compared to a method of individually manufacturing each hybrid lens.

However, when black stainless steel is used as the light-shielding portion in the lens array laminate and the lens array laminate is to be singulated through dicing into individual hybrid lenses, it is difficult to dice the lens array laminate into individual pieces with high precision. In order to reduce the dicing portion of the black stainless steel and minimize the load during dicing, it is conceivable to use, as the light-shielding portion, a light-shielding member in which individual light-shielding portions are joined by a runner. However, in this method, it is difficult to handle the resin lens array and the light-shielding member in aligning, and light cannot be sufficiently blocked near the outer periphery of each hybrid lens, and as a result, stray light easily enters. On the other hand, when a black resist is used as the light-shielding portion, the precision of etching that is implemented in forming the light-shielding portion is poor, the precision of the effective region is poor, and the black resist tends to peel from the glass.

In another known method, a chromium oxide layer formed by vapor deposition is used as the light-shielding portion. For example, Patent Document 2 discloses a method in which a metal film having a chromium oxide layer is formed on glass by a vapor deposition device, after which unnecessary resist is removed through etching to form a diaphragm, and then a resin is applied to the surface of the glass, the resin is cured while being pressed with a mold to form a resin part having a lens portion, and a wafer lens laminate is obtained.

### CITATION LIST

### Patent Document

Patent Document 1: WO 2019/131572
Patent Document 2: JP 2012-123239 A

### SUMMARY OF INVENTION

### Technical Problem

However, even when the glass and resin lens are bonded together using an adhesive, if the hybrid lens is exposed to a high temperature environment, floating in the adhesive layer and peeling between the glass and resin lens have occurred, which seems to occur due to the large difference in the linear expansion coefficients of the glass and resin lens.

Accordingly, a first object of the present disclosure is to provide a hybrid lens for which peeling and shifting between the glass and resin lens do not easily occur, and for which floating of the adhesive layer and peeling of the glass and resin lens do not easily occur even when the hybrid lens is exposed to a high temperature environment.

Furthermore, with the method disclosed in Patent Document 2, the light-shielding portion is formed by etching, and the resin part having the lens portion is directly formed on the glass, that is, both the light-shielding portion and the resin part are formed directly on the glass, and therefore a positional shifting easily occurs between the effective region of the lens and the light-transmitting portion of the light-shielding part. Moreover, as the quantity of individual lenses included in the lens array laminate increases, the positional shifting of the lenses located farther from the center portion of the lens array laminate tends to increase. Thus, it has been difficult to easily obtain a hybrid lens with good precision using a typical method.

Accordingly, a second object of the present disclosure is to provide an easily obtained hybrid lens in which a glass and a resin lens are laminated and in which the resin lens and the light-shielding portion are laminated with good precision, and to provide a hybrid lens (lens array laminate) capable of providing such a hybrid lens.

When a glass and a resin lens are laminated through an adhesive, it is difficult to uniformly apply the adhesive. Furthermore, when the adhesive is not uniformly applied, the clearance between the glass and the resin lens of the hybrid lens is not uniform, and when the hybrid lens is exposed to a high temperature environment, peeling may still occur between the glass and the resin lens.

Accordingly, a third object of the present disclosure is to provide a method for manufacturing a hybrid lens having a uniform clearance between the glass and the resin lens. In addition, a fourth object of the present disclosure is to provide a hybrid lens having a uniform clearance between the glass and the resin lens.

### Solution to Problem

As a result of diligent research to achieve the first object of the present disclosure, the inventors of the present disclosure discovered that when a glass substrate and a resin lens are bonded through an adhesive layer having a low glass transition temperature within a specific range and lower than the glass transition temperature of the resin lens, a hybrid lens can be obtained in which peeling and shifting between the glass and the resin lens do not easily occur, and in which floating of the adhesive layer and peeling between the glass and resin lens do not easily occur even when the hybrid lens is exposed to a high temperature environment.

Furthermore, as a result of diligent research to achieve the second object of the present disclosure, the inventors discovered that with respect to a hybrid lens in which a glass substrate, a metal compound layer, and a resin lens are laminated, an easily obtained hybrid lens in which the resin lens and a light-shielding portion are laminated with good precision can be obtained by joining the glass substrate and the resin lens through an adhesive layer.

Moreover, as a result of diligent research to achieve the third and fourth objects, the inventors of the present disclosure discovered that a hybrid lens having a uniform clearance between the glass and resin lens can be obtained by singulating a lens array into individual hybrid lenses, the lens array including, in the adhesive layer, a plurality of butting parts that connect the glass and resin lens mutually facing in a region other than a region that becomes a lens, or being such that the adhesive layer contains particles, and a maximum particle size of the particles is the same as a minimum thickness of the adhesive layer.

The present disclosure relates to inventions completed based on these findings.

A first aspect of the present disclosure provides a hybrid lens including a glass substrate, a resin lens provided on at least one surface of the glass substrate, and an adhesive layer provided between the glass substrate and the resin lens, wherein the glass transition temperature of the resin lens is higher than the glass transition temperature of the adhesive layer, and a difference between the glass transition temperature of the resin lens and the glass transition temperature of the adhesive layer is from 97 to 150° C.

When the abovementioned difference in glass transition temperatures of the hybrid lens is 97° C. or more, the adhesiveness between the glass substrate and the resin lens is sufficient, and the difference in the linear expansion coefficients brought about by thermal shock is alleviated, and thereby floating of the adhesive layer and peeling between the glass and the resin lens do not easily occur, even when the hybrid lens is exposed to a high temperature environment. By setting the difference in glass transition temperatures to 150° C. or less, for example, peeling and shifting between the glass substrate and the resin lens do not easily occur and excellent operability is obtained when each hybrid lens is obtained by cutting and singulating the lens array.

The glass transition temperature of the resin lens is preferably 140° C. or more.

The glass transition temperature of the adhesive layer is preferably 60° C. or less.

The adhesive layer is preferably a photocurable adhesive layer.

The adhesive layer preferably includes an epoxy-based resin and/or an acrylic-based resin.

The adhesive layer preferably includes an epoxy-based resin.

The epoxy-based resin preferably includes a constituent unit derived from an alicyclic epoxy compound.

The resin lens preferably includes an epoxy-based resin.

The epoxy-based resin preferably includes a constituent unit derived from an alicyclic epoxy compound.

A black layer is preferably provided between the glass substrate and the adhesive layer.

The black layer preferably contains a metal compound.

The adhesive layer preferably joins the black layer and the resin lens.

The resin lens preferably has a convex lens shape in the effective region.

The resin lens preferably includes a wall section extending in an optical axis direction and formed to surround the effective region.

A top portion of the wall section is preferably located at a position higher than a top portion of the convex lens shape in the optical axis direction.

A second aspect of the present disclosure provides a hybrid lens including a glass substrate, a resin lens provided on at least one surface of the glass substrate, an adhesive layer provided between the glass substrate and the resin lens, and a metal compound layer provided between the glass substrate and the resin lens.

The metal compound layer is preferably a black layer.

The metal compound layer preferably includes a metal oxide.

The metal compound layer preferably includes a chromium compound.

A difference in refractive indexes between the glass substrate and the adhesive layer and/or a difference in refractive indexes between the resin lens and the adhesive layer is preferably 0.1 or less.

The adhesive layer is preferably a photocurable adhesive layer.

The adhesive layer preferably includes an epoxy-based resin and/or an acrylic-based resin.

The adhesive layer preferably includes an epoxy-based resin.

The adhesive layer preferably joins the metal compound layer and the resin lens.

The metal compound layer is preferably provided on the glass surface.

The resin lens preferably has a convex lens shape in the effective region.

The resin lens preferably includes a wall section extending in an optical axis direction and formed to surround the effective region.

A top portion of the wall section is preferably located at a position higher than a top portion of the convex lens shape in the optical axis direction.

A third aspect of the present disclosure provides a method for manufacturing a hybrid lens, the method including singulating a lens array into individual hybrid lenses, the lens array including a glass substrate, a resin lens provided on at least one surface of the glass substrate, and an adhesive layer provided between the glass substrate and the resin lens, and the lens array satisfying a requirement (1) or (2):

(1) In a region of the lens array other than a region that is singulated into the individual hybrid lenses, the lens array includes, in the adhesive layer, a plurality of butting parts that connect the resin lens and the glass substrate mutually facing;

(2) The adhesive layer contains particles, and a maximum particle size of the particles is the same as a minimum thickness of the adhesive layer.

In a case in which the requirement (1) is satisfied, the plurality of butting parts are formed to connect the glass substrate and the resin lens mutually facing and to obtain a uniform clearance between the resin lens and the glass substrate in a connected state. Therefore, in a state in which the resin lens and the glass substrate are bonded together, the plurality of butting parts act as columns and uniformly maintain the clearance. Subsequently in the lens region, the clearance is filled with the adhesive. When the lens array is then singulated in this state, a hybrid lens having a uniform clearance between the glass and the resin lens can be manufactured.

In a case in which the above-described (2) is satisfied, when the resin lens and the glass substrate are to be bonded, the adhesive has fluidity, and therefore in a state in which, of the particles, the particles having the maximum particle size are sandwiched between the bonding surfaces of the resin lens and the glass substrate, the resin lens and the glass substrate are inevitably stopped at a position where the maximum particle size and the minimum thickness of the adhesive are the same. As a result, particles having the maximum particle size act as columns and thus uniformly maintain the clearance. Subsequently, in the lens region, the clearance is filled with the adhesive. When the lens array is then singulated in this state, a hybrid lens having a uniform clearance between the glass and the resin lens can be manufactured.

With respect to the requirement (2) above, the particles are preferably transparent particles.

With respect to the requirement (1) above, the butting parts are preferably positioned closer to an outer edge side in the lens array than an aggregated region in which individual regions that become the lens are aggregated.

With respect to the requirement (1) above, the butting parts are preferably integrally formed with the lens body.

The manufacturing method further includes, prior to the individual hybrid lens formation, bonding together the resin lens and the glass substrate to obtain a laminate, and preferably, a bonding surface of the resin lens is coated with an adhesive, which forms the adhesive layer.

In the bonding, the butting parts are preferably formed on the bonding surface of the resin lens.

In the bonding, preferably, a bonding surface of the glass substrate is coated with the adhesive, which forms the adhesive layer.

In the bonding, a black layer is preferably provided on the bonding surface of the glass substrate.

In the bonding, preferably, a black layer is partially provided on the bonding surface of the glass substrate, and at least a portion of a region where the black layer is not provided is coated with the adhesive, which forms the adhesive layer.

The adhesive layer preferably joins the black layer and a resin lens body.

The manufacturing method preferably includes curing the adhesive on the laminate obtained by the bonding to form an adhesive layer.

In the manufacturing method, preferably, the singulating is performed after the curing of the adhesive.

The lens array may satisfy the requirement (1). Furthermore, the lens array may satisfy the requirement (2).

A fourth aspect of the present disclosure provides a hybrid lens including a glass substrate, a resin lens provided on at least one surface of the glass substrate, and an adhesive layer provided between the glass substrate and the resin lens, wherein the adhesive layer contains particles, and a maximum particle size of the particles is the same as a minimum thickness of the adhesive layer.

The particles are preferably transparent particles.

A black layer is preferably provided between the glass substrate and the adhesive layer.

The adhesive layer preferably joins the black layer and the resin lens.

### Advantageous Effects of Invention

With the hybrid lens of the first aspect of the present disclosure, peeling and shifting between the glass and resin lens do not easily occur, and floating of the adhesive layer and peeling of the glass and resin lens do not easily occur even when the hybrid lens is exposed to a high temperature environment.

The hybrid lens of the second aspect of the present disclosure is a hybrid lens in which a glass and a resin lens are laminated, and thereby the hybrid lens can be easily obtained, and the resin lens and the light-shielding portion are laminated with high precision. Specifically, for example, by laminating a separately fabricated resin lens array to a glass using an adhesive layer, a hybrid lens (lens array laminate) in which the light-shielding portion and the resin lens array are laminated with good precision can be obtained. Furthermore, by dicing the lens array laminate, individual hybrid lenses can be easily obtained with good precision from the laminate including the light-shielding portion.

According to the method for manufacturing the hybrid lens of the third aspect of the present disclosure, a hybrid lens having uniform clearance between the glass and the resin lens can be obtained.

### BRIEF DESCRIPTION OF DRAWING

FIG. 1 is a schematic cross-sectional view illustrating an embodiment of a hybrid lens (A) of the present disclosure.

FIG. 2 is an external view of the hybrid lens (A) illustrated in FIG. 1.

FIG. 3 is a schematic cross-sectional view illustrating an embodiment of a hybrid lens (B) of the present disclosure.

FIG. 4 is an external view of the hybrid lens (B) illustrated in FIG. 3.

FIG. 5 is a flow chart illustrating an embodiment of the manufacturing method according to the present disclosure.

FIG. 6 is a cross-sectional schematic view illustrating an embodiment of bonding, adhesive curing, and singulating in the manufacturing method of the present disclosure.

FIG. 7 is a cross-sectional schematic view illustrating another embodiment of bonding, adhesive curing, and singulating in the manufacturing method of the present disclosure.

FIG. 8 is a top view of a lens array illustrated in FIG. 6(d).

FIG. 9 is a top view of a lens array according to another embodiment.

FIG. 10(a) is a cross-sectional schematic view illustrating an embodiment of a hybrid lens obtained by the manufacturing method of the present disclosure illustrated in FIG. 6, and FIG. 10(b) is an external view of the same.

FIG. 11 is a cross-sectional schematic view illustrating an embodiment of a hybrid lens obtained by the manufacturing method of the present disclosure illustrated in FIG. 7.

### DESCRIPTION OF EMBODIMENTS

### Hybrid Lens

### Hybrid Lens (A)

A hybrid lens of a first aspect according to an embodiment of the present disclosure includes a glass substrate, a resin lens provided on at least one surface of the glass substrate, and an adhesive layer provided between the glass substrate and the resin lens. In the hybrid lens, the glass substrate, the adhesive layer, and the glass substrate are laminated in this order along the optical axis direction. Note that in the present specification, the hybrid lens of the first aspect may be referred to as a “hybrid lens (A)”.

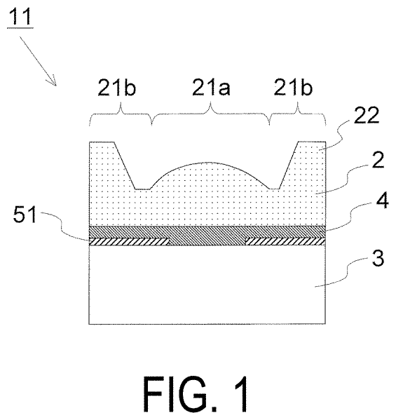

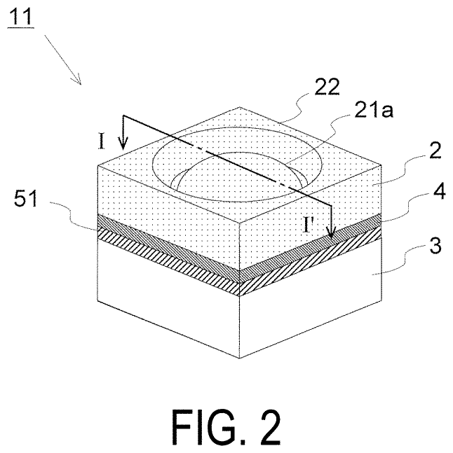

FIG. 1 and FIG. 2 illustrate cross-sectional schematic views representing one embodiment of the hybrid lens (A) of the present disclosure. FIG. 1 corresponds to a cross-sectional view along the cross section I-I′ illustrated in FIG. 2. The hybrid lens 11 includes a resin lens 2, a glass substrate 3, and an adhesive layer 4. The resin lens 2 is laminated on one surface of the glass substrate 3 with the adhesive layer 4 interposed therebetween. The adhesive layer 4 joins the resin lens 2 and the glass substrate 3.

The glass transition temperature of the resin lens is higher than the glass transition temperature of the adhesive layer. Furthermore, a difference in the glass transition temperatures between the resin lens and the adhesive layer is from 97 to 150° C., preferably from 98 to 130° C., and more preferably from 99 to 120° C. When the abovementioned difference in glass transition temperatures is 97° C. or more, the adhesiveness between the glass substrate and the resin lens is sufficient, and the difference in the linear expansion coefficients brought about by thermal shock is alleviated, and thereby floating of the adhesive layer and peeling between the glass and the resin lens do not easily occur, even when the hybrid lens is exposed to a high temperature environment. By setting the abovementioned difference in glass transition temperatures to 150° C. or less, for example, shifting between the glass substrate and the resin lens does not easily occur and excellent operability is obtained when singulated hybrid lenses are obtained by cutting the lens array. Furthermore, cohesive failure of the glass is less likely to occur.

The glass transition temperature of the resin lens is preferably 140° C. or more, and more preferably 150° C. or more. When the glass transition temperature is 140° C. or more, the heat resistance strength is sufficient, and deformation does not easily occur after a wafer lens is molded. The glass transition temperature of the resin lens is, for example, 200° C. or less, and preferably 190° C. or less. When the glass transition temperature is 200° C. or less, full curing in an annealing process is easily achieved, and the stress after molding is easily released. Note that in the present specification, the glass transition temperature of the resin lens is a value measured through dynamic mechanical analysis (DMA).

The glass transition temperature of the adhesive layer is preferably 62° C. or less, and more preferably 60° C. or less. When the glass transition temperature is 62° C. or less, adhesiveness between the glass substrate and the resin lens becomes more sufficient, and peeling is even less likely to occur, even when subjected to a high temperature environment. The glass transition temperature of the adhesive layer is preferably 30° C. or more, and more preferably 35° C. or more. When the glass transition temperature is 30° C. or more, whitening or yellowing is unlikely to occur even when the hybrid lens is exposed to a high temperature environment, and excellent transparency is achieved. Note that in the present specification, the glass transition temperature of the adhesive layer is a value measured by thermomechanical analysis (TMA). Also note that in some cases, a clear inflection point may not be present in the results of TMA measurements of the resin lens, and thus it is difficult to calculate the glass transition temperature from TMA measurements. Therefore, the glass transition temperature of the resin lens is calculated through DMA measurements.

Another layer besides the adhesive layer may be present between the glass substrate and the resin lens. Examples of the other layer include a layer that exhibits a black color (black layer), and an anti-reflective film (AR coating film).

The black layer is, for example, partially arranged not to entirely block the optical path, and thereby the black layer functions as a light-shielding member or a diaphragm of the hybrid lens (A). The black layer is preferably disposed at a position covering the non-effective region of the resin lens, and may be disposed to extend to a position covering the peripheral edge portion of the effective region. Furthermore, the black layer may be positioned on either the resin lens side or the glass substrate side, relative to the adhesive layer. Of these, the black layer is preferably positioned on the glass substrate side relative to the adhesive layer, and is preferably provided on the surface of the glass substrate. When the black layer is provided, the adhesive layer preferably joins the black layer and the resin lens or the glass substrate. In a case where the black layer is provided on the surface of the glass substrate, generally, the black layer tends to be easily damaged in association with floating of the adhesive layer when exposed to a high temperature environment, but with the hybrid lens (A), floating of the adhesive layer in a high temperature environment does not easily occur, and thus the black layer is less likely to be damaged.

The anti-reflective film is provided on an end surface of the hybrid lens (A) (for example, a surface of the glass substrate, the surface thereof being on the side opposite the resin lens, or a surface of the resin lens, the surface thereof being on the side opposite the glass substrate), and reduces the reflection of light incident on the hybrid lens.

The anti-reflective film is configured from a single layer or multiple layers of a metal oxide coating. Materials such as SiO₂, ZrO₂, Al₂O₃, and TiO₂ are commonly used as the material of the metal oxide. When the anti-reflective film is configured with multiple layers, the materials forming each layer may be the same or different.

Examples of the anti-reflective film include films (vapor-deposited coating films) formed by, for example, a vapor deposition method. Examples of the vapor deposition method include dry plating methods (or dry coating methods) such as vacuum vapor deposition, ion plating, sputtering, a CVD method, and a PVD method. As the vacuum deposition method, an ion beam assist method in which ion beams are simultaneously irradiated during the vapor deposition may be used.

The thickness of the anti-reflective film is preferably adjusted, as appropriate, depending on the intended use, and for example, in a case of use for preventing the reflection of visible light rays, the thickness of the anti-reflective film is, for example, approximately from 60 to 150 nm, preferably from 80 to 120 nm, and particularly preferably from 90 to 110 nm.

In the hybrid lens 11 illustrated in FIGS. 1 and 2, a black layer 51 is provided between the resin lens 2 and the glass substrate 3, closer to the glass substrate 3 side than the adhesive layer 4. The black layer 51 is partially provided on the surface of the glass substrate 3 at a position overlapping a non-effective region 21b and a peripheral edge portion of an effective region 21a in the optical axis direction, and thus the black layer 51 covers the non-effective region 21b and the peripheral edge portion of the effective region 21a of the resin lens 2. The adhesive layer 4 joins the resin lens 2 and the glass substrate 3, and also joins the resin lens 2 and the black layer 51.

### Hybrid Lens (B)

A hybrid lens of a second aspect according to an embodiment of the present disclosure includes a glass substrate, a resin lens provided on at least one surface of the glass substrate, an adhesive layer provided between the glass substrate and the resin lens, and a metal compound layer provided between the glass substrate and the resin lens. In the hybrid lens, the glass substrate, the adhesive layer, the metal compound layer, and the glass substrate are laminated along the optical axis direction. The lamination order of the adhesive layer and the metal compound is not particularly limited. Note that in the present specification, the hybrid lens of the second aspect may be referred to as a “hybrid lens (B)”. Also, in the present specification, if the “hybrid lens (A)” and the “hybrid lens (B)” are not clearly differentiated, the description pertains to both hybrid lenses.

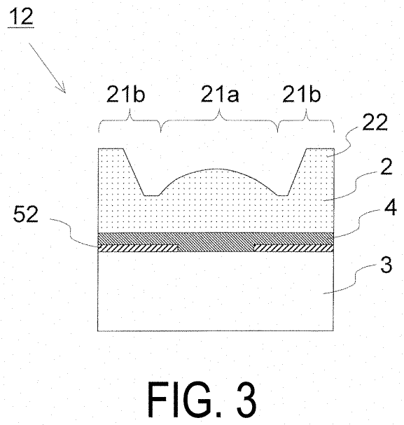

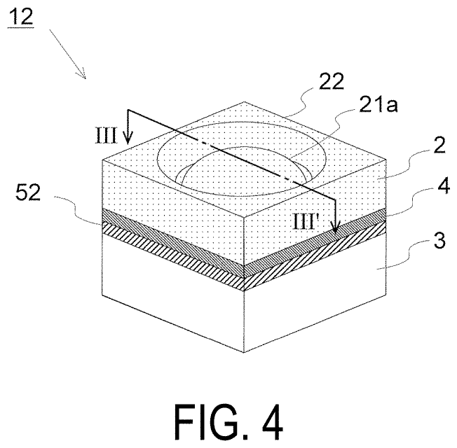

FIG. 3 and FIG. 4 illustrate cross-sectional schematic views representing one embodiment of the hybrid lens of the present disclosure. FIG. 3 corresponds to a cross-sectional view along the cross section III-III′ illustrated in FIG. 4. The hybrid lens 12 illustrated in FIGS. 3 and 4 is an individual hybrid lens obtained by singulating the lens array laminate and includes a resin lens 2, a glass substrate 3, an adhesive layer 4, and a metal compound layer 52. The resin lens 2 is laminated on one surface of the glass substrate 3 with the adhesive layer 4 interposed therebetween. The adhesive layer 4 joins the resin lens 2 and the glass substrate 3.

The metal compound layer is partially arranged not to entirely blocking the optical path, and thereby the metal compound layer functions as a light-shielding portion (optical diaphragm) of the hybrid lens (B). That is, the metal compound layer has a light-shielding property that enables the metal compound layer to function as a light-shielding portion in the hybrid lens (B). The metal compound layer is preferably a layer that exhibits a black color (black layer). From the perspective of suppressing penetration of stray light, the metal compound layer is preferably disposed at a position covering the non-effective region of the resin lens, and may be disposed to extend to a position covering the peripheral edge portion of the effective region. Furthermore, the metal compound layer may be positioned on either the resin lens side or the glass substrate side, of the adhesive layer. Of these, the metal compound layer is preferably positioned on the glass substrate side relative to the adhesive layer, and is preferably provided on the surface of the glass substrate. The adhesive layer preferably joins the metal compound layer and the resin lens or the glass substrate. This is because when the metal compound layer is provided on the surface of the glass substrate, generally, the resin lens and the glass substrate tend to be easily peeled off when exposed to a high temperature environment, but with the hybrid lens (B), peeling is less likely to occur in a high temperature environment. In addition, with the hybrid lens (B), floating of the adhesive layer is less likely to occur in a high temperature environment, and the metal compound layer is not easily damaged.

In the hybrid lens 12 illustrated in FIGS. 3 and 4, a metal compound layer 52 is provided between the resin lens 2 and the glass substrate 3 closer to the glass substrate 3 side than the adhesive layer 4. The metal compound layer 52 is partially provided on the surface of the glass substrate 3 at a position overlapping a non-effective region 21b and the peripheral edge portion of an effective region 21a in the optical axis direction, and thus covers the non-effective region 21b and the peripheral edge portion of the effective region 21a of the resin lens 2. The adhesive layer 4 joins the resin lens 2 and the glass substrate 3, and also joins the resin lens 2 and the metal compound layer 52.

The hybrid lens (B) may be provided with another layer other than the above-mentioned layers. Examples of the other layer include the anti-reflective film as an example of other layers that may be provided in the hybrid lens (A). Further, for example, as the other layer, another substrate and/or lens may be laminated to overlap the glass substrate or a region including the effective region of the resin lens, in the optical axis direction.

The anti-reflective film is provided on an end surface of the hybrid lens (B) (for example, a surface of the glass substrate, the surface thereof being on the side opposite the resin lens, or a surface of the resin lens, the surface thereof being on the side opposite the glass substrate), and reduces the reflection of light incident on the hybrid lens.

The resin lens has at least a region (effective region) that effectively exhibits a function as a lens, such as having a light condensing property in the case of a convex lens. The resin lens may have a region (non-effective region) besides the effective region. Additionally, at least one surface (in particular, a surface on the side opposite the side on which the glass substrate is positioned) of the effective region preferably has a convex lens shape (spherical surface shape) or a concave lens shape. The other surface of the effective region may have any of a convex lens shape, a concave lens shape, a planar shape, a shape in which the outer peripheral edge of these shapes is raised in an annular shape, or the like.

The resin lens preferably has, in the non-effective region, a wall section extending in an optical axis direction and formed to surround the effective region from a side surface. In other words, the resin lens preferably has an effective region in a recess formed in the upper surface (the surface of the side opposite the side at which the glass substrate is positioned). By having the wall section, the hybrid lens does not become thin walled, and the strength of the lens is easily maintained. Additionally, the top portion of the wall section (the portion having the highest height in the optical axis direction) is preferably located at a position higher than the top portion of the effective region (a portion in the effective region having the highest height in the optical axis direction). With such a positional relationship, damage to the effective region in handling of the lens array (wafer lens) can be prevented, and the distance from the top portion of the effective region to the top portion of the wall section can be set as the focal length.

In the hybrid lenses 11, 12 illustrated in FIGS. 1 to 4, the resin lens 2 includes, on the upper surface (the surface of the side opposite the side at which the glass substrate 3 is positioned), the effective region 21a formed from a convex lens, the non-effective region 21b, and the wall 22, which is formed in the non-effective region 21b, extends in the optical axis direction, and is formed in the non-effective region 21b to surround the effective region 21a from the side surface. The wall section 22 is formed along the peripheral edge of the resin lens 2. As illustrated in FIGS. 1 and 3, the top portion of the wall section 22 is located at a position having a higher height in the optical axis direction than the top portion of the effective region 21a. The lower surface of the resin lens 2 (the surface of the side at which the glass substrate 3 is positioned) is planar. In FIGS. 2 and 4, the upper surface shape of the recess is a perfect circle, but the upper surface of the recess is not limited to such a shape, and may be, for example, a polygon shape (in particular, a regular polygon), another circular shape such as an ellipse, or a shape in which a corner section of a polygon shape is rounded.

The glass substrate may have a region (effective region) that effectively exhibits a function as a lens, or in other words, may be a lens. The glass substrate may also not have the effective region. If the glass substrate has the effective region, the glass substrate functions as a lens. Examples of the effective region include a region having a convex lens shape or a concave lens shape. Of the glass substrate, the upper surface (the surface of the side at which the resin lens is positioned) and the lower surface (the surface of the side opposite the side at which the resin lens is positioned) may each have a shape having a convex lens shape or a concave lens shape, a planar shape, or a shape in which the outer peripheral edge of these shapes is raised in an annular shape. Note that the lower surface of the resin lens and the upper surface of the glass substrate are preferably parallel from the perspective of achieving a configuration in which peeling is less likely to occur.

In the hybrid lenses 11, 12 illustrated in FIGS. 1 to 4, the glass substrate 3 has a shape in which the upper surface (surface of the side at which the resin lens 2 is positioned) and the lower surface (surface of the side opposite the side at which the resin lens 2 is positioned) are planar shapes. The lower surface of the resin lens 2 and the upper surface of the glass substrate 3 are both planar and are mutually facing and parallel to each other.

The adhesive layer is positioned between the resin lens and the glass substrate. The adhesive layer may directly join (adhere) the resin lens and the glass substrate, or may indirectly join (adhere) the resin lens and the glass substrate through another layer. The adhesive layer may have a single layer structure or may have a multilayer structure.

The hybrid lens may be configured such that as the other layer, another substrate and/or lens is laminated to overlap the glass substrate or a region including the effective region of the resin lens, in the optical axis direction.

Examples of the hybrid lens include optical lenses, such as a microlens and a Fresnel lens. In addition, examples of the optical lenses include an imaging lens (camera lens), or a lens for a sensor of a mobile electronic device, such as a mobile phone or a smartphone. Moreover, the hybrid lens may also be a lens array (wafer-level lens array), in particular a microlens array, having a configuration in which two or more lenses (i.e., a plurality of lens parts) are arranged two-dimensionally (perpendicular to the optical axis), and these lenses are connected through joining parts.

Each of the lens parts in the lens array can have a shape according to the purpose. The shape of each lens part in the lens array may be the same, or may be different.

The shape of the lens array is not particularly limited, and examples thereof include a plate shape, a sheet shape, and a film shape. The thickness of the lens (the thickness of a flat section in which the recess is not formed) is, for example, from 40 to 1200 μm (provided that the thickness range is greater than the maximum depth of the recess formed in the lens).

### Resin Lens

Examples of the resin constituting the resin lens include olefin-based resins, acrylic-based resins (such as methacrylate-based resins), styrene-based resins (for example, acrylonitrile-styrene copolymers, methyl methacrylate-styrene copolymers, and methyl methacrylate-modified acrylonitrile-butadiene-styrene copolymers (transparent ABS resins)), polycarbonate-based resins, polyamide-based resins (such as alicyclic polyamide resins), polyester-based resins, epoxy-based resins, and silicone-based resins. The resin may be a thermoplastic resin or may be a curable resin (such as a thermosetting resin or a photocurable resin). Examples of the curable resin include epoxy-based resins, acrylic-based resins, and silicone-based resins. A single type of resin may be used, or two or more types may be used.

Among these, the resin is preferably an epoxy-based resin. The epoxy-based resin is a resin containing at least a constituent unit derived from an epoxy compound. The epoxy compound is a compound having one or more epoxy groups (oxiranyl groups) per molecule. Among these, the epoxy compound is preferably a compound having two or more epoxy groups (preferably from 2 to 6, more preferably from 2 to 4) per molecule.

The epoxy compound is not particularly limited, and a well-known or commonly used epoxy compound can be used. Examples thereof include alicyclic epoxy compounds, aliphatic epoxy compounds such as aliphatic polyglycidyl ether, aromatic epoxy compounds, heterocyclic epoxy compounds, and siloxane derivatives having one or more epoxy group per molecule. A single type of epoxy compound may be used, or two or more thereof may be used.

Examples of the alicyclic epoxy compound include well-known or commonly used compounds that have one or more alicyclic rings and one or more epoxy groups in the molecule. The alicyclic epoxy compound is not particularly limited, and examples thereof include: (I) a compound having an epoxy group (referred to as an “alicyclic epoxy group”) in the molecule, the epoxy group being constituted of two adjacent carbon atoms and an oxygen atom and constituting an alicyclic ring; (II) a compound in which an epoxy group is directly bonded to an alicyclic ring through a single bond; and (III) a compound having an alicyclic ring and a glycidyl ether group in the molecule (a glycidyl ether type epoxy compound).

Examples of the compound (I) having an alicyclic epoxy group in the molecule include a compound represented by Formula (i):

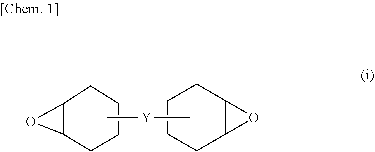

In Formula (i), Y represents a single bond or a linking group (a divalent group having one or more atoms). Examples of the linking group include a divalent hydrocarbon group, an epoxidized alkenylene group in which some or all of the carbon-carbon double bonds are epoxidized, a carbonyl group, an ether bond, an ester bond, a carbonate group, an amide group, and a linked group in which a plurality of the above groups are linked. Note that substituents such as alkyl groups may be bonded to one or more of the carbon atoms constituting the cyclohexane ring (cyclohexene oxide group) in Formula (i).

Examples of the divalent hydrocarbon group include a linear or branched alkylene group having from 1 to 18 carbon atoms and a divalent alicyclic hydrocarbon group. Examples of the linear or branched alkylene group having from 1 to 18 carbon atoms include a methylene group, a methylmethylene group, a dimethylmethylene group, an ethylene group, a propylene group, and a trimethylene group. Examples of the divalent alicyclic hydrocarbon group include divalent cycloalkylene groups (including a cycloalkylidene group), such as a 1,2-cyclopentylene group, a 1,3-cyclopentylene group, a cyclopentylidene group, a 1,2-cyclohexylene group, a 1,3-cyclohexylene group, a 1,4-cyclohexylene group, and a cyclohexylidene group.

Examples of the alkenylene group in the epoxidized alkenylene group in which some, or all of the carbon-carbon double bonds are epoxidized (the group thereof may be referred to as an “epoxidized alkenylene group”) include linear or branched alkenylene groups having from 2 to 8 carbons, such as a vinylene group, a propenylene group, a 1-butenylene group, a 2-butenylene group, a butadienylene group, a pentenylene group, a hexenylene group, a heptenylene group, and an octenylene group. In particular, the epoxidized alkenylene group is preferably an epoxidized alkenylene group in which all of the carbon-carbon double bonds are epoxidized, and more preferably an epoxidized alkenylene group having from 2 to 4 carbons in which all of the carbon-carbon double bonds are epoxidized.

Representative examples of the alicyclic epoxy compound represented by Formula (i) include (3,4,3′,4′-diepoxy)bicyclohexyl and compounds represented by Formulae (i-1) to (i-10). In Formulae (i-5) and (i-7), l and m each represent an integer from 1 to 30. R′ in Formula (i-5) is an alkylene group having from 1 to 8 carbons, and, among these, a linear or branched alkylene group having from 1 to 3 carbons, such as a methylene group, an ethylene group, a propylene group, or an isopropylene group, is preferable. In Formulae (i-9) and (i-10), n1 to n6 each represent an integer from 1 to 30. In addition, other examples of the alicyclic epoxy compound represented by the formula (i) include 2,2-bis(3,4-epoxycyclohexyl)propane, 1,2-bis(3,4-epoxycyclohexan-1-yl)ethane, 1,2-epoxy-1,2-bis(3,4-epoxycyclohexan-1-yl)ethane, and bis(3,4-epoxycyclohexylmethyl)ether.

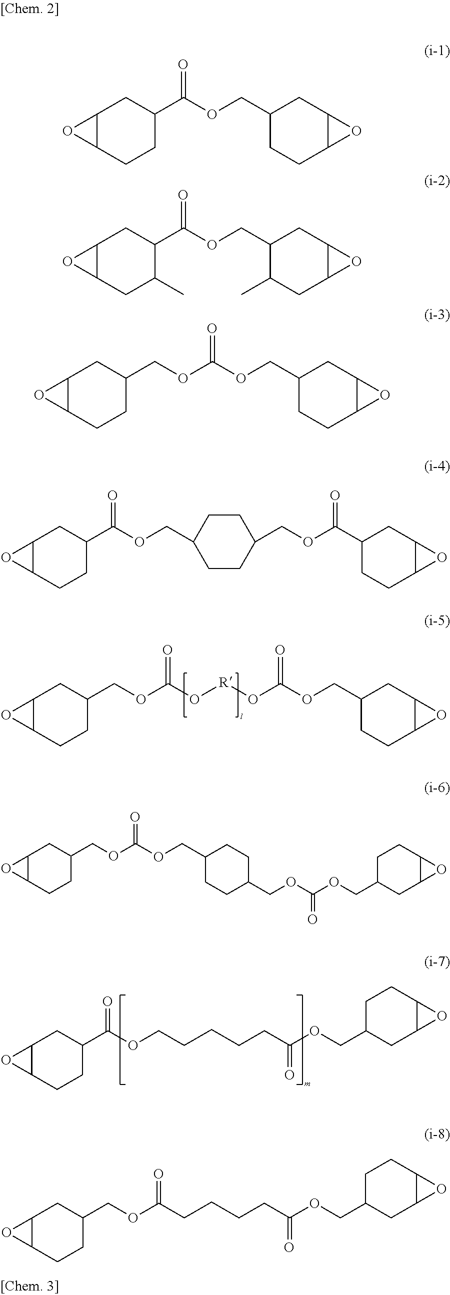

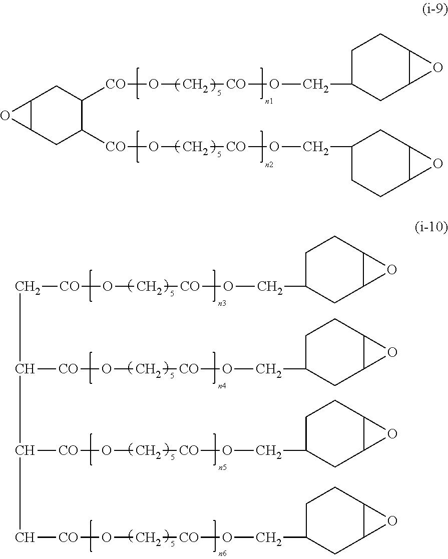

Examples of the compound (I) having an alicyclic epoxy group in the molecule include epoxy-modified siloxanes. Examples of the epoxy-modified siloxanes include a chain or cyclic polyorganosiloxane having a constituent unit represented by Formula (i′).

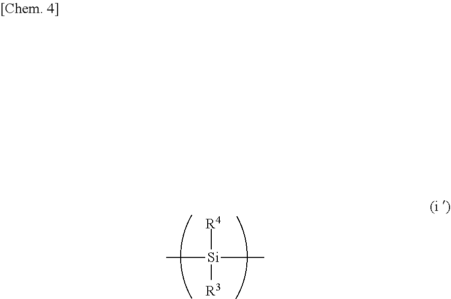

In Formula (i′), R³ represents a substituent containing a group represented by Formula (1a) or a substituent containing a group represented by formula (1b), and R⁴ represents an alkyl group or an alkoxy group.

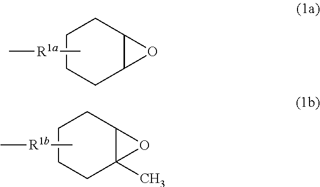

In the Formulae (Ta) and (Tb), R^{1a} and R^{1b} may be the same or different, and each represents a linear or branched alkylene group, and examples thereof include linear or branched alkylene groups having from 1 to 10 carbons, such as a methylene group, a methyl methylene group, a dimethyl methylene group, an ethylene group, a propylene group, a trimethylene group, a tetramethylene group, a pentamethylene group, a hexamethylene group, and a decamethylene group.

The epoxy equivalent (in accordance with JIS K7236) of the epoxy-modified siloxane is, for example, from 100 to 400, and preferably from 150 to 300.

A commercially available product, such as a compound represented by Formula (i′-1) (product name “KR-470”, available from Shin-Etsu Chemical Co., Ltd.), for example, can be used as the epoxy-modified siloxane.

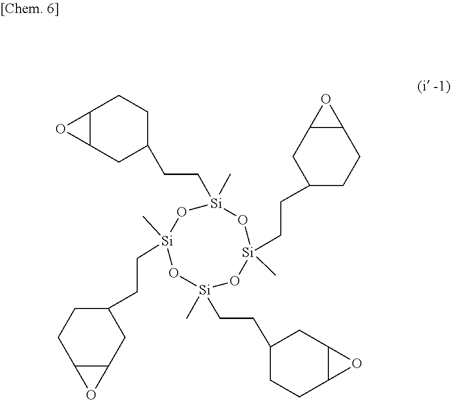 [SMILES: C[Si]1(CCC2CCC3OC3C2)O[Si](C)(CCC2CCC3OC3C2)O[Si](C)(CCC2CCC3OC3C2)O[Si](C)(CCC2CCC3OC3C2)O1]

Examples of the compound (II) in which an epoxy group is directly bonded to an alicyclic ring through a single bond include compounds represented by Formula (ii).

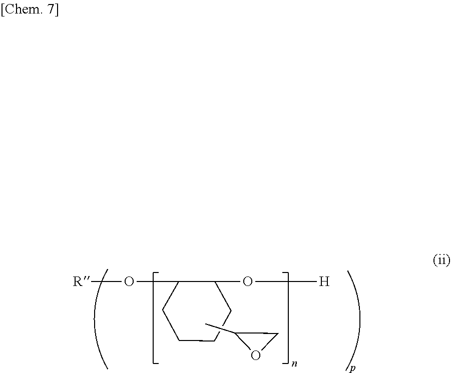

In Formula (ii), R″ is a group resulting from elimination of a quantity of p hydroxyl groups (—OH) from a structural formula of a p-hydric alcohol (p-valent organic group), where p and n each represent a natural number. Examples of the p-hydric alcohol [R″(OH)ₚ] include polyhydric alcohols (such as alcohols having from 1 to 15 carbons), such as 2,2-bis(hydroxymethyl)-1-butanol. Here, p is preferably from 1 to 6, and n is preferably from 1 to 30. When p is 2 or greater, n in each group in parentheses (in the outer parentheses) may be the same or different. Specific examples of the compound represented by Formula (ii) include a 1,2-epoxy-4-(2-oxiranyl)cyclohexane adduct of 2,2-bis(hydroxymethyl)-1-butanol (such as a product of the trade name “EHPE3150” (available from Daicel Corporation)).

Examples of the compound (III) having an alicyclic ring and a glycidyl ether group in the molecule include glycidyl ethers of alicyclic alcohols (in particular, alicyclic polyhydric alcohols). More particularly, examples thereof include compounds obtained by hydrogenating a bisphenol A type epoxy compound (hydrogenated bisphenol A type epoxy compounds), such as 2,2-bis[4-(2,3-epoxypropoxy)cyclohexyl]propane and 2,2-bis[3,5-dimethyl-4-(2,3-epoxypropoxy)cyclohexyl]propane; compounds obtained by hydrogenating a bisphenol F type epoxy compound (hydrogenated bisphenol F type epoxy compounds), such as bis[o,o-(2,3-epoxypropoxy)cyclohexyl]methane, bis[o,p-(2,3-epoxypropoxy)cyclohexyl]methane, bis[p,p-(2,3-epoxypropoxy)cyclohexyl]methane, and bis[3,5-dimethyl-4-(2,3-epoxypropoxy)cyclohexyl]methane; a hydrogenated bisphenol type epoxy compound; a hydrogenated phenol novolac type epoxy compound; a hydrogenated cresol novolac type epoxy compound; a hydrogenated cresol novolac type epoxy compound of bisphenol A; a hydrogenated naphthalene type epoxy compound; a hydrogenated epoxy compound of an epoxy compound obtained from trisphenolmethane; and a hydrogenated epoxy compound of an epoxy compound having another aromatic ring.

The aromatic epoxy compound is a compound having one or more aromatic rings (aromatic hydrocarbon rings or aromatic heterocyclic rings) and one or more epoxy groups in the molecule. The aromatic epoxy compound is preferably a compound (aromatic glycidyl ether-based epoxy compound) in which a glycidoxy group is bonded to one or more carbons constituting an aromatic ring (particularly an aromatic hydrocarbon ring) having carbon atoms.

Examples of the aromatic epoxy compound include an epibis type glycidyl ether type epoxy-based resin obtained by a condensation reaction of a bisphenol (such as bisphenol A, bisphenol F, bisphenol S, and fluorenebisphenol) and an epihalohydrin; a high molecular weight epibis type glycidyl ether type epoxy-based resin obtained by further subjecting the above epibis type glycidyl ether type epoxy-based resin to an addition reaction with a bisphenol described above; a novolac alkyl type glycidyl ether type epoxy-based resin obtained by subjecting a phenol (such as cresol, xylenol, resorcin, catechol, bisphenol A, bisphenol F, and bisphenol S) and an aldehyde (such as formaldehyde, acetaldehyde, benzaldehyde, hydroxybenzaldehyde, and salicylaldehyde) to a condensation reaction to obtain a polyhydric alcohol, and then further subjecting the polyhydric alcohol to condensation reaction with an epihalohydrin; and an epoxy compound in which two phenol skeletons are bonded at the 9-position of a fluorene ring, and glycidyl groups are each bonded directly or via an alkyleneoxy group to an oxygen atom resulting from eliminating a hydrogen atom from a hydroxyl group of these phenol skeletons.

Examples of the aliphatic epoxy compound include glycidyl ethers of q-hydric alcohols having no cyclic structure (where q is a natural number); glycidyl esters of monovalent or polyvalent carboxylic acids (e.g., acetic acid, propionic acid, butyric acid, stearic acid, adipic acid, sebacic acid, maleic acid, or itaconic acid); epoxidized materials of fats and oils having a double bond, such as epoxidized linseed oil, epoxidized soybean oil, and epoxidized castor oil; and epoxidized materials of polyolefins (including polyalkadienes), such as epoxidized polybutadiene. Here, examples of the q-hydric alcohols having no cyclic structure include monohydric alcohols, such as methanol, ethanol, 1-propyl alcohol, isopropyl alcohol, and 1-butanol; dihydric alcohols, such as ethylene glycol, 1,2-propanediol, 1,3-propanediol, 1,4-butanediol, neopentyl glycol, 1,6-hexanediol, diethylene glycol, triethylene glycol, tetraethylene glycol, dipropylene glycol, polyethylene glycol, and polypropylene glycol; and trihydric or higher polyhydric alcohols, such as glycerin, diglycerin, erythritol, trimethylolethane, trimethylolpropane, pentaerythritol, dipentaerythritol, and sorbitol. In addition, the q-hydric alcohol may be a polyether polyol, a polyester polyol, a polycarbonate polyol, a polyolefin polyol, or the like.

Among these, as the epoxy compound, preferably an alicyclic epoxy compound is included, and more preferably a compound having an alicyclic epoxy group and a compound having an alicyclic ring and a glycidyl ether group in the molecule are included. As the compound having an alicyclic epoxy group, preferably a compound represented by the above formula (i) and an epoxy-modified siloxane are included. Furthermore, as the epoxy compound, an aromatic epoxy compound may be included.

The content ratio of the constituent units derived from the epoxy compound in the epoxy-based resin is, in relation to the total amount (100 mass %) of all constituent units constituting the epoxy-based resin, preferably 10 mass % or more, more preferably 20 mass % or more, even more preferably 50 mass % or more, yet even more preferably 70 mass % or more, still even more preferably 80 mass % or more, and particularly preferably 90 mass % or more.

The epoxy-based resin may include a constituent unit derived from a cationically-curable compound other than an epoxy compound (hereinafter also referred to as “another cationically-curable compound”). One type of the constituent unit derived from another cationically-curable compound may be used alone, or two or more types may be used.

Examples of the other cationically-curable compound include compounds having one or more oxetane groups per molecule (may be referred to as “oxetane compounds”), and compounds having one or more vinyl ether groups per molecule (may be referred to as “vinyl ether compounds”). Use of another cationically-curable compound can result in improvements in mechanical strength, thermal stability, reliability, and optical properties (refractive index, etc.) of the resin lens.

Examples of the oxetane compound include well-known or commonly used compounds including one or more oxetane rings in the molecule. The oxetane compound is not particularly limited, and specific examples thereof include 3,3-bis(vinyloxymethyl)oxetane, 3-ethyl-3-(hydroxymethyl)oxetane, 3-ethyl-3-(2-ethylhexyloxymethyl)oxetane, 3-ethyl-3-[(phenoxy)methyl]oxetane, 3-ethyl-3-(hexyloxymethyl)oxetane, 3-ethyl-3-(chloromethyl)oxetane, 3,3-bis(chloromethyl)oxetane, 1,4-bis[(3-ethyl-3-oxetanylmethoxy)methyl]benzene, bis{[1-ethyl(3-oxetanyl)]methyl}ether, 4,4′-bis[(3-ethyl-3-oxetanyl)methoxymethyl]bicyclohexyl, 1,4-bis[(3-ethyl-3-oxetanyl)methoxymethyl]cyclohexane, 1,4-bis{[(3-ethyl-3-oxetanyl)methoxy]methyl}benzene, 3-ethyl-3-{[(3-ethyloxetan-3-yl)methoxy]methyl}oxetane, xylylenebisoxetane, 3-ethyl-3-{[3-(triethoxysilyl)propoxy]methyl}oxetane, oxetanylsilsesquioxane, and phenol novolac oxetane.

The vinyl ether compound is not particularly limited, and a well-known and commonly used compound including one or more vinyl ether groups in the molecule can be used. Examples thereof include 2-hydroxyethyl vinyl ether (ethylene glycol monovinyl ether), 3-hydroxypropyl vinyl ether, 2-hydroxypropyl vinyl ether, 2-hydroxyisopropyl vinyl ether, 4-hydroxybutyl vinyl ether, 3-hydroxybutyl vinyl ether, 2-hydroxybutyl vinyl ether, 3-hydroxyisobutyl vinyl ether, 2-hydroxyisobutyl vinyl ether, 1-methyl-3-hydroxypropyl vinyl ether, 1-methyl-2-hydroxypropyl vinyl ether, 1-hydroxymethylpropyl vinyl ether, 4-hydroxycyclohexyl vinyl ether, 1,6-hexanediol monovinyl ether, 1,6-hexanediol divinyl ether, 1,8-octanediol divinyl ether, 1,4-cyclohexanedimethanol monovinyl ether, 1,4-cyclohexanedimethanol divinyl ether, 1,3-cyclohexanedimethanol monovinyl ether, 1,3-cyclohexanedimethanol divinyl ether, 1,2-cyclohexanedimethanol monovinyl ether, 1,2-cyclohexanedimethanol divinyl ether, p-xylene glycol monovinyl ether, p-xylene glycol divinyl ether, m-xylene glycol monovinyl ether, m-xylene glycol divinyl ether, o-xylene glycol monovinyl ether, o-xylene glycol divinyl ether, ethylene glycol divinyl ether, diethylene glycol monovinyl ether, diethylene glycol divinyl ether, triethylene glycol monovinyl ether, triethylene glycol divinyl ether, tetraethylene glycol monovinyl ether, tetraethylene glycol divinyl ether, pentaethylene glycol monovinyl ether, pentaethylene glycol divinyl ether, oligoethylene glycol monovinyl ether, oligoethylene glycol divinyl ether, polyethylene glycol monovinyl ether, polyethylene glycol divinyl ether, dipropylene glycol monovinyl ether, dipropylene glycol divinyl ether, tripropylene glycol monovinyl ether, tripropylene glycol divinyl ether, tetrapropylene glycol monovinyl ether, tetrapropylene glycol divinyl ether, pentapropylene glycol monovinyl ether, pentapropylene glycol divinyl ether, oligopropyleneglycol monovinyl ether, oligopropyleneglycol divinyl ether, polypropylene glycol monovinyl ether, polypropylene glycol divinyl ether, isosorbide divinyl ether, oxanorbornene divinyl ether, phenyl vinyl ether, n-butyl vinyl ether, isobutyl vinyl ether, octyl vinyl ether, cyclohexyl vinyl ether, hydroquinone divinyl ether, 1,4-butanediol divinyl ether, cyclohexanedimethanol divinyl ether, trimethylolpropane divinyl ether, trimethylolpropane trivinyl ether, bisphenol A divinyl ether, bisphenol F divinyl ether, hydroxyoxanorbornane methanol divinyl ether, 1,4-cyclohexanediol divinyl ether, pentaerythritol trivinyl ether, pentaerythritol tetravinyl ether, dipentaerythritol pentavinyl ether, and dipentaerythritol hexavinyl ether.

The resin lens may include an additive other than the resin. Examples of the additive include stabilizers (thermal stabilizers, ultraviolet absorbers, antioxidants, etc.), plasticizers, lubricants, fillers, colorants, flame retardants, antistatic agents, laser light absorbers, internal mold release agents, and acid generators (photoacid generators, thermal acid generators). Examples of the internal mold release agent include well-known or commonly used internal mold release agents such as fluorine-based, silicone-based, and stearate-based internal mold release agents.

### Glass Substrate

The glass substrate is not particularly limited, and a well-known or commonly used glass can be used, such as quartz, aluminosilicate glass, and borosilicate glass. A single type of glass may be used, or two or more types may be used.

### Adhesive Layer

The adhesive layer includes a resin as a binder component. Examples of the resin include olefin-based resins, acrylic-based resins, styrene-based resins, polycarbonate-based resins, polyamide-based resins, polyester-based resins, epoxy-based resins, and silicone-based resins. The resin may be a thermoplastic resin or may be a curable resin (such as a thermosetting resin or a photocurable resin). Among these, a curable resin is preferable, and a photocurable resin is more preferable. That is, the adhesive layer is preferably a curable adhesive layer, and more preferably a photocurable adhesive layer. Examples of the curable resin include epoxy-based resins, acrylic-based resins, and silicone-based resins. Among these, the resin is preferably an epoxy-based resin or an acrylic-based resin. A single type of resin may be used, or two or more types may be used.

The epoxy compound constituting the epoxy-based resin is preferably a compound having two or more (preferably from 2 to 6, more preferably from 2 to 4) epoxy groups per molecule.

Examples of the epoxy compound include those exemplified and described as an epoxy compound constituting an epoxy resin that may be included in the resin lens described above. Among these, the epoxy compound is preferably an alicyclic epoxy compound, and is more preferably a compound having an alicyclic ring and a glycidyl ether group in the molecule. Furthermore, the alicyclic epoxy compound may further include a compound having an alicyclic epoxy group. A single type of epoxy compound may be used, or two or more thereof may be used.

In relation to the total amount (100 mass %) of all constituent units constituting the epoxy-based resin, the content ratio of the constituent units derived from an epoxy compound in the epoxy-based resin is preferably 10 mass % or more, more preferably 20 mass % or more, even more preferably 50 mass % or more, and yet even more preferably 70 mass % or more. The content ratio thereof is also preferably 99 mass % or less, and more preferably 95 mass % or less.

The epoxy-based resin may include a constituent unit derived from the other cationically-curable compound. Among the other cationically-curable compounds, an oxetane compound is preferable. One type of the constituent unit derived from “another cationically-curable compound” may be used alone, or two or more types may be used.

The content ratio of the constituent units derived from another cationically-curable compound in the epoxy-based resin is, in relation to the total amount (100 mass %) of all constituent units constituting the epoxy-based resin, preferably from 1 to 50 mass %, and more preferably from 5 to 40 mass %.

The adhesive layer may contain an additive besides the resin. Examples of the additive include stabilizers (thermal stabilizers, ultraviolet absorbers, antioxidants, etc.), plasticizers, lubricants, filling agents (fillers), colorants, flame retardants, antistatic agents, laser light absorbers, silane coupling agents, and acid generators (photoacid generator, thermal acid generator).

The reflectance at the interface between the resin lens and the adhesive layer is preferably 0.5% or less, more preferably 0.1% or less, even more preferably 0.05% or less, and particularly preferably 0.01% or less. Furthermore, the reflectance at the interface between the glass substrate and the adhesive layer is preferably within the range described above.

A difference in refractive indexes between the glass substrate and the adhesive layer and/or a difference in refractive indexes between the resin lens and the adhesive layer is preferably 0.1 or less, more preferably 0.08 or less, and even more preferably 0.05 or less. When the difference in refractive indexes is 0.1 or less, an interfacial reflection of light at each interface is less likely to occur.

The thickness of the adhesive layer is preferably from 10 to 100 μm, and more preferably from 30 to 50 μm. When the thickness is 10 μm or more, peeling between the resin lens and the glass substrate is less likely to occur.

### Black Layer

A well-known or commonly used light-blocking material or material that is used in a diaphragm part can be used as the constituent material of the above-described black layer of the hybrid lens (A), and an organic material or an inorganic material can be used. Examples of the organic material include resin materials, such as polyethylene resin, polypropylene resin, polyamide resin, polyester resin, polyethylene terephthalate resin, polybutylene terephthalate resin, polyether resin, polycarbonate resin, acrylic resin, polyimide resin, polyether ketone resin, polyether ether ketone resin, polyether sulfone resin, and polyphenyl sulfone resin. Examples of the inorganic material include glass and metal compounds, such as iron (for example, stainless steel, SUS). A single type of the above-mentioned constituent material may be used, or two or more types may be used.

From the perspective of obtaining a hybrid lens in which peeling does not easily occur in attempting to obtain the hybrid lens by cutting from a lens array, and from the perspective of achieving superior etching resistance, among these constituent materials of the black layer, the constituent material thereof is preferably an inorganic material, more preferably a metal compound, and even more preferably a metal oxide. In particular, from the perspectives of being able to form the black layer by patterning on the glass substrate and facilitating positioning, and from the perspective of being able to easily form a thin layer and achieve a configuration in which peeling from the glass substrate does not easily occur during cutting the lens array, the black layer is preferably a layer containing a chromium compound (particularly, chromium oxide). In a case in which the black layer is an inorganic material, generally, the black layer is hard, and therefore the black layer tends to be easily damaged in association with floating of the adhesive layer when exposed to a high temperature environment, but with the hybrid lens (A), floating of the adhesive layer in a high temperature environment does not easily occur, and thus the black layer is less likely to be damaged.

### Metal Compound Layer

In the hybrid lens (B), the metal compound layer is used as a light-shielding portion, and thereby the lens array laminate in which the resin lens, the adhesive layer, the metal compound layer, and the glass substrate are laminated can be easily diced with good precision. Therefore, it is not necessary to reduce the dicing portion of the light-shielding portion or alleviate the load during dicing, and the penetration of stray light near the outer periphery can be suppressed. Furthermore, since the metal compound layer exhibits excellent etching resistance, the metal compound layer can be easily formed with good precision through etching. Further, the metal compound layer does not easily peel from the resin lens or the glass substrate.

Examples of the constituent material of the metal compound layer include well-known or commonly used metal compounds having light-shielding properties, and of these, metal oxides are preferable. In particular, from the perspective of being able to form the metal compound layer by patterning on the glass substrate and facilitating positioning, and from the perspective of being able to easily form a thin layer and achieving a configuration in which peeling from the glass substrate does not easily occur during cutting the lens array, the metal compound layer is preferably a layer containing a chromium compound (particularly, chromium oxide). In addition, the metal compound layer is generally hard, and therefore the metal compound layer tends to be easily damaged in association with floating of the adhesive layer when exposed to a high temperature environment, but with the hybrid lens according to an embodiment of the present disclosure, floating of the adhesive layer in a high temperature environment does not easily occur, and the metal compound is less likely to be damaged.

The metal compound layer is preferably a vapor-deposited layer from the perspective of being able to easily form a layer having a uniform film thickness.

### Method for Manufacturing Hybrid Lens (A)

The hybrid lens (A) can be manufactured by using a resin lens and a glass substrate that have been processed in advance into a predetermined shape, coating the joining surface of the glass substrate and/or the joining surface of the resin lens with an adhesive composition that forms the adhesive layer, bonding the joining surfaces together, and then curing the adhesive composition as necessary. When the hybrid lens (A) has a black layer, the hybrid lens (A) can be manufactured by, for example, first forming the black layer on the glass substrate surface by patterning or the like, bonding, in the same manner as described above, the joining surface of the resin lens and the black layer-formed surface of the glass substrate on which the black layer has been formed, and then curing the adhesive composition as necessary.

### Method for Manufacturing Hybrid Lens (B)

The hybrid lens (B) can be manufactured, for example, by the following method. First, a resin lens and a glass substrate that have been processed into a predetermined shape are used, and the metal compound layer is formed on the glass substrate and/or the resin lens. The metal compound layer can be formed, for example, by forming a uniform layer of a metal compound on the surface of the glass substrate by a known method such as vapor deposition, sputtering, or PVD, and then patterning by removing through etching the metal compound layer in a region serving as a light-transmitting portion.

Next, an adhesive composition that forms the adhesive layer is applied to the joining surface of the glass substrate and/or the joining surface of the resin lens, and the joining surfaces are bonded together. The metal compound layer is formed on the joining surface of the glass substrate and/or the joining surface of the resin lens.

Subsequently, the adhesive composition is cured as necessary. In this manner, a hybrid lens that is a lens array laminate is obtained. Also, the individual hybrid lenses can be obtained by dicing the lens array laminate.

In the hybrid lens (B), the resin lens and the glass substrate are laminated through an adhesive layer. Therefore, even when the metal compound layer is adopted as a light-shielding portion, the hybrid lens (B) excels in adhesiveness between the resin lens and the glass substrate produced in advance. Furthermore, by using the adhesive layer in this way, the hybrid lens (B) can be manufactured by a method other than directly forming both the light-shielding portion and the resin lens on the glass, and therefore positional shifting between the effective region of the lens and the light-transmitting portion of the light-shielding portion does not easily occur, and a high precision hybrid lens (B) can be obtained.

Furthermore, the lens array laminate is obtained by bonding together the resin lens array and the glass substrate through a light-shielding portion in which a plurality of light-transmitting portions are formed. In addition, when the lens array laminate is to be diced, the laminate including the light-shielding portion can be easily diced when the metal compound layer is used as the light-shielding portion, and thus the lens array laminate can be diced with good precision, and individual hybrid lenses (B) can be easily obtained. Furthermore, as the quantity of individual lenses included in the lens array laminate increases, positional shifting of the lenses located far from the center of the lens array laminate tends to increase, but the hybrid lens laminate according to an embodiment of the present disclosure exhibits good precision even with lenses located far from the center of the lens array laminate, and positional shifting between the effective region of the lens and the light-transmitting portion of the light-shielding portion is suppressed.

Also, the lens array laminate adopts the metal compound layer as the light-shielding portion and thus can be diced with good precision, and therefore it is not necessary to reduce the dicing parts of the light-shielding portion. Accordingly, it is not necessary to use a light-shielding member in which individual light-shielding portions are joined by a runner, and each member is easily handled during alignment. In addition, it is possible to avoid the problem of stray light easily entering due to insufficient light shielding near the outer periphery of each hybrid lens.

Furthermore, with the hybrid lens (B), peeling and shifting between the glass and resin lens do not easily occur, and even when the hybrid lens (B) is exposed to a high temperature environment, floating of the adhesive layer and peeling of the glass and resin lens do not easily occur. On the other hand, with a hybrid lens in which the resin lens and the glass substrate are directly laminated, the difference in the linear expansion coefficients of the resin lens and the glass substrate increases in high temperature environments, and thus peeling easily occurs. Furthermore, even when exposed to a high temperature environment, the hybrid lens (B) does not easily undergo whitening or yellowing, and tends to exhibit excellent transparency.

### Method for Manufacturing Hybrid Lens

A method for manufacturing a hybrid lens of a third aspect according to an embodiment of the present disclosure includes at least singulating a lens array into hybrid lenses (singulating), the lens array including a glass substrate, a resin lens provided on at least one surface of the glass substrate, and an adhesive layer provided between the glass substrate and the resin lens. The lens array has a plurality of lenses (effective regions of lenses) aligned and joined in a direction perpendicular to the optical axis.

The lens array used in the individual hybrid lens formation satisfies the requirement (1) or (2) described below. For a case in which the lens array satisfies the requirement (1), the manufacturing method may be referred to as the “first embodiment” of the manufacturing method. Also, for a case in which the lens array satisfies the requirement (2), the manufacturing method may be referred to as the “second embodiment” of the manufacturing method.

(1) In a region of the lens array other than a region that is singulated into the individual hybrid lenses, the lens array includes, in the adhesive layer, a plurality of butting parts that connect the resin lens and glass substrate mutually facing;

(2) The adhesive layer contains particles, and a maximum particle size of the particles is the same as a minimum thickness of the adhesive layer.

The manufacturing method may include other steps in addition to the singulating. Examples of the other steps include applying an adhesive, which forms the adhesive layer, to the glass substrate and/or the resin lens (adhesive application), bonding together the resin lens and the glass substrate through an adhesive to obtain a laminate (bonding), and curing the adhesive to form an adhesive layer (adhesive curing). The singulating may be implemented after the bonding, or may be implemented before or after the adhesive curing.

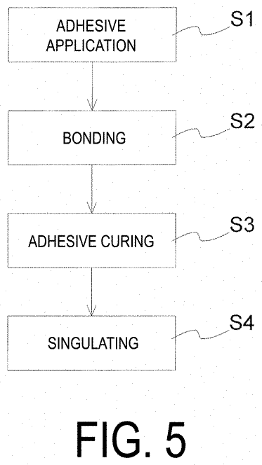

FIG. 5 illustrates an embodiment of the manufacturing method. The manufacturing method illustrated in FIG. 5 includes adhesive application S1, bonding S2, adhesive curing S3, and singulating S4, in this order.

The resin lens includes at least a resin lens body that is a resin substrate having a lens shape. In the singulating, the resin lens body includes, on a surface of a side opposite the bonding surface, a region (effective region) that effectively exhibits a function as a lens, such as having a light condensing property in the case of a convex lens. The resin lens is a lens array in which a plurality of the effective regions are aligned and coupled together in a direction perpendicular to the optical axis. The resin lens preferably has a shape corresponding to the shape of the hybrid lens obtained through the singulating. In particular, preferably, the resin lens has, alternating in a direction perpendicular to the optical axis, an effective region and a region (non-effective region) in which the function as a lens is not effectively exhibited, and more preferably, the resin lens has recesses and protrusions alternated in the direction perpendicular to the optical axis, and has an effective region (particularly a convex lens shape) within each of the recesses, and the protrusions are non-effective regions. When the effective region has a convex lens shape, the height of the top portion of the convex lens is preferably lower than the height of the protrusion in the non-effective region. Note that the resin lens body used in the adhesive application, the bonding, and the adhesive curing may be a resin substrate on which an effective region such as a convex lens shape is not formed, or may be a resin lens array. The surface (bonding surface) of the side opposite the effective region may have a convex lens shape, a concave lens shape, a planar shape, a shape in which the outer peripheral edge of these shapes is raised in an annular shape, or the like, but is preferably a planar shape. At the bonding surface of the resin lens, a region (may be referred to as a “lens region”) that becomes a hybrid lens obtained through the singulating is preferably a planar shape. The resin lens may include other layers or members besides the resin lens body.

The glass substrate includes at least a glass substrate body that is a substrate made of glass. The glass substrate body may be a substrate in which an effective region is not formed on a surface opposite the bonding surface, or the effective region may be formed for a case in which the glass substrate body functions as a lens in the hybrid lens. When the glass substrate body has an effective region, the glass substrate body is preferably a lens array in which a plurality of the effective regions are aligned and coupled in a direction perpendicular to the optical axis. In addition, in this case, the effective region may be formed when implementing the singulating, and the glass substrate body that is used in the adhesive application, the bonding, and the adhesive curing may be a substrate on which an effective region such as a convex lens shape is not formed, or may be a lens array. The glass substrate may include other layers or members besides the glass substrate body.

In addition, for the purpose of enhancing the adhesion of the adhesive layer, the bonding surface of the resin lens and/or the bonding surface of the glass substrate may be subjected to a surface treatment. Examples of the surface treatment include: a physical treatment, such as a corona discharge treatment, a plasma treatment, a sand-matting treatment, an ozone exposure treatment, a flame exposure treatment, a high-voltage electric shock exposure treatment, and an ionizing radiation treatment; a chemical treatment such as a chromic acid treatment; and a treatment for facilitating adherence through a coating agent (base coating agent). The entire bonding surface of the resin lens and/or the entire bonding surface of the glass substrate is preferably subjected to the surface treatment for enhancing adhesion.

Examples of the other layer that may be provided in the resin lens and glass substrate include the black layer and anti-reflective film exemplified and described above as layers that may be provided in the hybrid lens (A).

The black layer is, for example, partially arranged not to entirely block the optical path, and thereby the black layer functions as a light-shielding member (diaphragm) of the hybrid lens. In a state in which the resin lens and the glass substrate are laminated, the black layer is preferably disposed at a position covering the non-effective region of the resin lens, and may be disposed to extend to a position covering the peripheral edge portion of the effective region. Of these configurations, the black layer is preferably present on the bonding surface of the glass substrate, and is more preferably provided on the surface of the glass substrate body.

The anti-reflective film is provided on an end surface of the hybrid lens (for example, a surface of the glass substrate, the surface thereof being on the side opposite the resin lens, or a surface of the resin lens, the surface thereof being on the side opposite the glass substrate), and reduces the reflection of light incident on the hybrid lens.

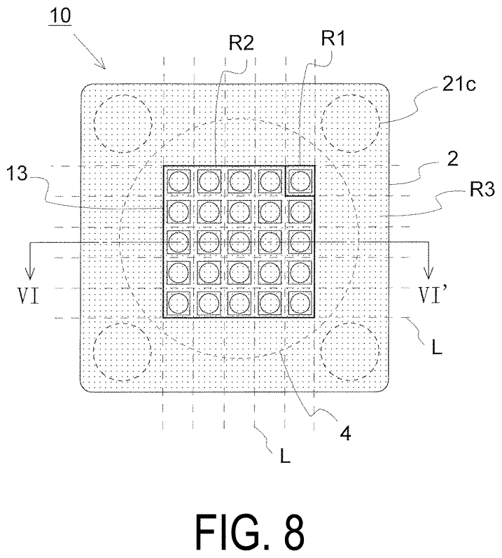

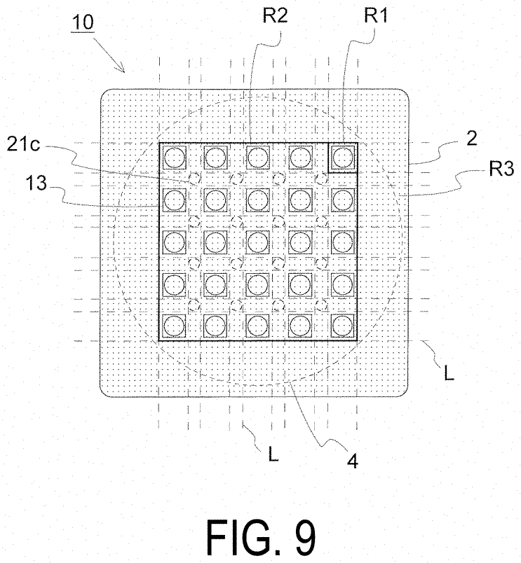

An example of the other member that may be provided in the resin lens and the glass substrate includes the butting part. In the first embodiment, the resin lens and/or the glass substrate includes the butting part. The resin lens or the glass substrate may have all of the butting parts, or the resin lens and the glass substrate may each have some of the butting parts thereof. The butting parts are formed in a region (may be referred to as a “non-lens region”) of the bonding surface of the resin lens and/or the glass substrate, excluding a region (lens region) that becomes the hybrid lens. The butting parts may be formed between individual lens regions in a region (aggregated region) where individual regions that become a hybrid lens are aggregated, or may be formed at the outer edge side (periphery) of the aggregated region (for example, see FIG. 8). However, preferably, the butting parts are formed at the outer edge side of the aggregated region and are not formed between the individual lens regions. As an example in which the butting parts are formed between the individual lens regions in the aggregated region, for example, butting parts are formed at locations where the lens region is not present in the longitudinal direction and the lateral direction in a state in which the lens regions are arranged in a lattice shape as illustrated in FIG. 9.

The total number of butting parts may be 2 or more, and from the perspective of achieving a more stably uniform clearance between the resin lens body and the glass substrate body, the total number thereof is preferably 3 or more. For example, as illustrated in FIG. 8, when the butting parts are formed on the outer edge side of the aggregated region, the total number of butting parts is more preferably 4. Additionally, in a case where the butting parts are formed between the individual lens regions, the number of butting parts is determined according to the number of lens regions in the lens array, and when a quantity of n×m lens regions are arranged in a lattice shape, the quantity of butting portions that are present is preferably (n−1)×(m−1).

The plurality of butting parts are formed to connect the resin lens and the glass substrate in the hybrid lens, and in which, in the connected state, the clearance between the resin lens body and the glass substrate body is uniform. An example in which the plurality of butting parts are formed in a manner in which the clearance is uniform includes an aspect in which the heights of the plurality of butting parts are the same, the connection points between the resin lens and the plurality of butting parts are on the same plane, and the connection points between the glass substrate and the plurality of butting parts are on the same plane. Another example includes an aspect in which one butting part connects the resin lens body and the glass substrate body, another butting part connects the resin lens body and the black layer formed on the glass substrate body, and the height of the one butting part is the same as a total of the height of the other butting part and the thickness of the black layer. Note that the “same” described above is not limited to being exactly the same and includes a state in which slight differences may be present as long as the clearance between the glass substrate body and the resin lens body can be made uniform with the plurality of butting parts. The shape of the butting part is not particularly limited, and examples include a columnar shape, a weight shape, or the like. The shapes of the plurality of butting parts may be the same or different. Additionally, the butting parts may be formed integrally with the resin lens body or the glass substrate body, or may be separately manufactured and affixed.

Each region of the resin lens 2 will be described with reference to FIGS. 8 and 9. FIG. 8 is a top view of a lens array 10. In the resin lens 2 of FIG. 8, a quantity of 25 lens regions R1 that become individual hybrid lenses 13 through the singulation, and a non-lens region R3, which is a region that is not used as a lens when the resin lens 2 is singulated, are present. An aggregated region R2 is a region in which the 25 lens regions R1 are aggregated, and is a region that includes all of the lens regions R1. The butting parts 21c are formed in the non-lens region R3, specifically, on the outer edge side of the aggregated region R2.

FIG. 9 is a top view of a lens array 10 according to another embodiment. In the resin lens 2 of FIG. 9, a quantity of 25 lens regions R1 that become individual hybrid lenses 13 through the singulation, and a non-lens region R3, which is a region that is not used as a lens when the resin lens 2 is singulated, are present. An aggregated region R2 is a region in which the 25 lens regions R1 are aggregated, and is a region that includes all of the lens regions R1. Note that unlike FIG. 8, the aggregated region R2 includes the non-lens region R3 in addition to the lens region R1. In addition, with the lens regions R1 arranged in a lattice shape, the butting parts 21c are formed in the non-lens region R3 within the aggregated region R2, at locations where the lens regions R1 are not present in either the longitudinal direction or lateral direction.

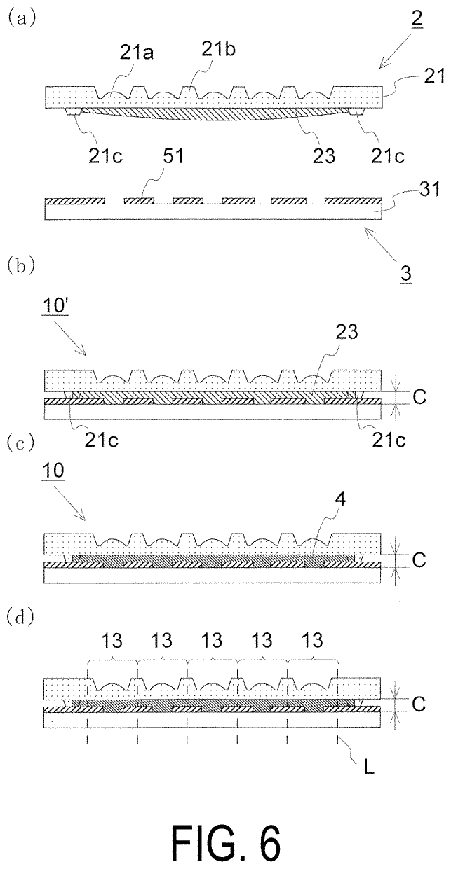

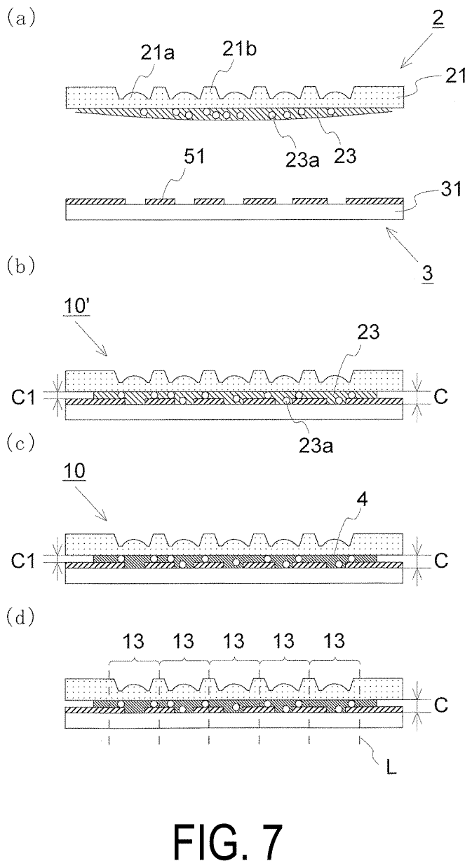

FIG. 6 illustrates one embodiment of the bonding, the adhesive curing, and the singulating in the first embodiment. FIG. 7 illustrates an embodiment of the bonding, the adhesive curing, and the singulating in the second embodiment. The resin lens 2 in the first embodiment illustrated in FIG. 6(a) and in the second embodiment illustrated in FIG. 7(a) includes a resin lens body 21. One surface of the resin lens body 21 has an effective region 21a having a convex lens shape and a non-effective region 21b. The top portion of the convex lens shape of the effective region 21a is at a position lower than the height of the non-effective region 21b. The resin lens body 21 is a lens array in which a plurality of effective regions 21a and a plurality of non-effective regions 21b are aligned and alternately coupled in a direction perpendicular to the optical axis. In the resin lens 2 illustrated in FIG. 6(a), four butting parts 21c having a columnar shape are formed on the other surface (bonding surface) of the resin lens body 21. The plurality of butting parts 21c are integrally formed with the resin lens body 21. FIG. 8 is a top view of the lens array illustrated in FIG. 6(d). FIG. 6(d) is a cross-sectional view along the cross section VI-VI′ of FIG. 8. Additionally, as illustrated in FIG. 8, four butting parts 21c are formed specifically at the outer edge side (periphery) of the aggregated region, at positions corresponding to the four corners of the substantially square shape that is the shape of the resin lens 2.

The glass substrate 3 of the first embodiment illustrated in FIG. 6(a) and the glass substrate 3 of the second embodiment illustrated in FIG. 7(a) includes a glass substrate body 31 and a black layer 51 partially formed on one surface of the glass substrate body 31. The glass substrate body 31 does not have an effective region. The black layer 51 is provided on a surface (bonding surface) of the glass substrate body 31 and is partially disposed, in the hybrid lens, to extend to a position covering the non-effective regions 21b of the resin lens and to a position covering the peripheral edge portion of the effective region 21a in the hybrid lens. The black layer 51 is partially formed on the bonding surface of the glass substrate 3, and thus the bonding surface has steps. The thickness of the black layer 51 is, for example, approximately 0.25 μm in the case of a chromium layer and approximately 1 to 2 μm in the case of the black resist material, and the step in relation to the thickness of the adhesive layer that is formed is extremely small.

### Adhesive Application

In the adhesive application, an adhesive (adhesive composition) for forming the adhesive layer is applied to the bonding surface of the glass substrate and/or the bonding surface of the resin lens, and preferably to both bonding surfaces.

The adhesive is applied to the bonding surface of the resin lens to be coated and/or to the bonding surface of the glass substrate to be coated. From the perspectives of the adhesive easily wet-spreading in bonding, and air bubbles not easily remaining in the adhesive layer that is formed, the adhesive is preferably applied to both the bonding surface of the resin lens to be coated and the bonding surface of the glass substrate to be coated.

Furthermore, from the perspective of air bubbles not easily remaining in the adhesive layer that is formed, the adhesive is preferably applied to, of the resin lens and the glass substrate, the side on which the lens region is planar. When the lens regions on both bonding surfaces are planar, the adhesive may be applied to either or both of the resin lens and the glass substrate. For example, in a case where the glass substrate has a black layer formed partially as described above, the lens region has a step formed by a region having the black layer and a region not having the black layer, and thus the lens region in the bonding surface of the glass substrate is not planar.

The adhesive used in the second embodiment includes particles. Well-known or commonly used organic particles and inorganic particles can be used as the particles. The particles are preferably transparent particles from the perspective of maintaining higher light transmittance in the hybrid lens.

The adhesive can be applied by a well-known or commonly used application method. Examples of the application method include spin coating, roll coating, spray coating, dispense coating, dip coating, and inkjet coating.

In the embodiments illustrated in FIG. 6(a) and FIG. 7(a), the adhesive is applied to the resin lens 2. In the resin lens 2, the adhesive 23 is applied to the bonding surface, which is the planar shape of the resin lens body 21, and thereby the adhesive 23 coats all of the lens regions, but does not include the regions where the butting parts 21c are formed. In the resin lens 2 of the second embodiment illustrated in FIG. 7(a), the adhesive 23 includes particles 23a.

### Bonding

In the bonding, the resin lens and the glass substrate are disposed in a manner that the bonding surfaces of both are mutually facing, positioning is implemented as necessary, and the bonding surfaces are brought into contact and are bonded together through the adhesive, and thereby a laminate is created. At this time, when the adhesive is applied to the bonding surfaces of both the resin lens and the glass substrate, the adhesives immediately spread out over the entire bonding surfaces from the moment that the adhesives are brought into mutual contact, and air bubbles are not easily produced. In the above positioning, for example, the resin lens and the glass substrate are positioned to a level at which an alignment mark of the resin lens and an alignment mark of the glass substrate are aligned within an error of 5 μm or less.

The bonding is preferably implemented under pressurization from the perspective of avoiding as much as possible an impact from thermal expansion, and improving the bonding precision. The pressure upon pressurization is, for example, from 1 to 80 kPa per a resin lens surface area of from 100 to 10000 mm². The temperature under pressurization is preferably normal temperature.

In the first embodiment illustrated in FIG. 6(a) and the second embodiment illustrated in FIG. 7(a), in the bonding, the bonding surface of the resin lens 2 and the bonding surface of the glass substrate 3 are arranged to be mutually facing, and positioning is implemented, and as illustrated in FIGS. 6(b) and 7(b), the bonding surfaces are brought into mutual contact and are bonded through an adhesive 23 to thereby create a laminate 10′.

In the first embodiment illustrated in FIG. 6(b), the four columnar butting parts 21c in the laminate 10′ have the same height, the connecting surfaces between the four butting parts 21c and the resin lens body 21 are on the same plane, and the connecting surfaces between the four butting parts 21c and the glass substrate 3 are also on the same plane. The connecting surfaces of the four butting parts 21c with the glass substrate 3 are all the black layer 51 formed on the glass substrate body 31. Thus, in the laminate 10′, the four butting parts 21c act as columns to uniformly maintain a clearance C between the resin lens body 21 and the glass substrate body 31. The clearance C in the lens regions is filled with the adhesive.

In this manner, in the first embodiment, the butting parts are formed on the bonding surface of the resin lens and/or the bonding surface of the glass substrate. The plurality of butting parts are formed to connect the mutually facing glass substrate and resin lens and to obtain a uniform clearance between the resin lens and the glass substrate in a connected state. Therefore, in a state in which the resin lens and the glass substrate are bonded together, the plurality of butting parts act as columns and uniformly maintain the clearance. Subsequently in the lens region, the clearance is filled with the adhesive. When the lens array is then singulated in this state, a hybrid lens having a uniform clearance between the glass and the resin lens can be manufactured.

In the second embodiment illustrated in FIG. 7(b), of the particles 23a in the laminate 10′, particles having a maximum particle size are sandwiched and held between the resin lens 2 and the glass substrate 3. The particles having the maximum particle size are sandwiched and held (between the resin lens body 21 and the black layer 51 in FIG. 7(b)) at positions of the narrowest clearance C1 of the clearance formed by the resin lens 2 and the glass substrate 3. Each of the particles sandwiched at the positions thereof act as a column in the laminate 10′, and thereby the clearance C between the resin lens body 21 and the glass substrate body 31 is uniformly maintained. The clearance C in the lens regions is filled with the adhesive.

In this manner, in the second embodiment, the adhesive includes particles. In this case, when the resin lens and the glass substrate are to be bonded, the adhesive has fluidity, and therefore in a state in which, of the particles, the particles having the maximum particle size are sandwiched between the bonding surfaces of the resin lens and the glass substrate, the resin lens and the glass substrate are inevitably stopped at a position where the maximum particle size and the minimum thickness of the adhesive are the same. As a result, particles having the maximum particle size act as columns and thus uniformly maintain the clearance. Subsequently, in the lens region, the clearance is filled with the adhesive. When the lens array is then singulated in this state, a hybrid lens having a uniform clearance between the glass and the resin lens can be manufactured.

After the bonding, the adhesive is positioned between the resin lens and the glass substrate. The adhesive may directly join (adhere) the resin lens body and the glass substrate body, or may indirectly join (adhere) the resin lens body and the glass substrate body through another layer (black layer or the like).

After the bonding, the adhesive may be additionally injected, as necessary, between the resin lens and the glass substrate. In the additional injection, the adhesive is preferably not injected into a region overlapping the effective region in the optical axis direction.

### Adhesive Curing

In the adhesive curing, the adhesive is cured in the laminate body created in the bonding, and the adhesive layer is formed. Examples of the curing include curing through irradiation with active energy rays (photo-curing), curing through heat (thermosetting), curing through moisture (moisture curing), and two-pack reaction-type curing (two-pack reaction curing). Note that when curing progresses at normal temperature, it is not necessary to separately implement curing processes such as irradiation with active energy rays and heating. Among these, photo-curing is preferable from the perspective of excellent workability and stability. Therefore, the adhesive is preferably a one liquid part-type curable composition (in particular, a one liquid part-type photocurable composition). The irradiation with active energy rays may be implemented from any direction of the above-described laminate, but from the perspective of more sufficient irradiation of the active energy rays, the irradiation with active rays is preferably implemented from the resin lens side.

As the active energy rays, for example, any of infrared rays, visible rays, ultraviolet rays, X-rays, an electron beam, an α-ray, a β-ray, and a γ-ray can be used. Among these, ultraviolet rays are preferred in terms of excellent handling.

Examples of the light source used when irradiating with ultraviolet rays include a high-pressure mercury-vapor lamp, an ultrahigh-pressure mercury-vapor lamp, a carbon-arc lamp, a xenon lamp, a metal halide lamp, and an ultraviolet LED (UV-LED). The irradiation time depends on the type of the light source, the distance between the light source and the coated surface, and other conditions, but is several tens of seconds at the longest. The illuminance is approximately from 5 to 200 mW. After the irradiation with ultraviolet rays, the curable composition may be heated (post-curing) as necessary to facilitate curing.

In the first embodiment illustrated in FIG. 6(b) and the second embodiment illustrated in FIG. 7(c), in the adhesive curing, the adhesive 23 filled between the resin lens 2 and the glass substrate 3 is cured while the clearance C is maintained, and the adhesive layer 4 is formed to thereby fabricate the lens array 10. In FIG. 6(c) and FIG. 7(c), the clearance C between the resin lens body 21 and the glass substrate body 31 is uniformly maintained, even in a state in which the adhesive layer 4 is formed.

In the lens array formed through the adhesive curing, the adhesive layer is positioned between the resin lens and the glass substrate. The adhesive layer may directly join (adhere) the resin lens body and the glass substrate body, or may indirectly join (adhere) the resin lens body and the glass substrate body through another layer (black layer or the like). In the lens array 10 illustrated in FIG. 6(c) and FIG. 7(c), the adhesive layer 4 joins the black layer 51 and the resin lens body 21, and joins the glass substrate body 31 and the resin lens body 21. The adhesive layer may have a single layer structure or may have a multilayer structure.

In the lens array obtained in the first embodiment, the butting parts are present in the adhesive layer and connect the resin lens and the glass substrate, which are mutually facing.

After the adhesive application, after the bonding, or after the adhesive curing, the effective regions may be formed on the resin lens and/or the glass substrate as necessary.

### Singulating

In the singulating, the lens array, which includes the resin lens, the glass substrate, and the adhesive layer provided between the resin lens and the glass substrate, is singulated into individual hybrid lenses. In the singulating, each lens region is cut (diced), and thus each of all of the hybrid lenses has the effective region.

The means for singulating is not particularly limited, and a well-known or commonly used means can be used, but of these means, use of a blade rotating at a high speed is preferable. In cutting using a blade rotating at high speed, the rotation speed of the blade is, for example, approximately from 10000 to 50000 rpm. Furthermore, cutting the lens array using a blade rotating at high speed may generate frictional heat, and therefore the lens array is preferably cut while being cooled to suppress deformation of the lens and a reduction in optical properties due to the frictional heat.

In the first embodiment illustrated in FIG. 6(d) and the second embodiment illustrated in FIG. 7(d), in the singulating, the lens array is cut in the optical axis direction along cutting lines L illustrated in the drawings while the clearance C is maintained. In the lens array 10 illustrated in FIG. 8, the regions that are cut to form the hybrid lenses 13 include lens regions R1 aligned continuously in five columns by five rows, and therefore the cutting is implemented along six vertical cutting lines L and six horizontal cutting lines L. On the other hand, in the lens array 10 illustrated in FIG. 9, the regions that are cut to form the hybrid lenses 13 include the lens regions R1 aligned in five columns by five rows with non-lens regions R3 interposed therebetween, and therefore the cutting is implemented along ten vertical cutting lines L and ten horizontal cutting lines L. Through the above cutting, a plurality of hybrid lenses 13 are obtained.

### Hybrid Lens (C)

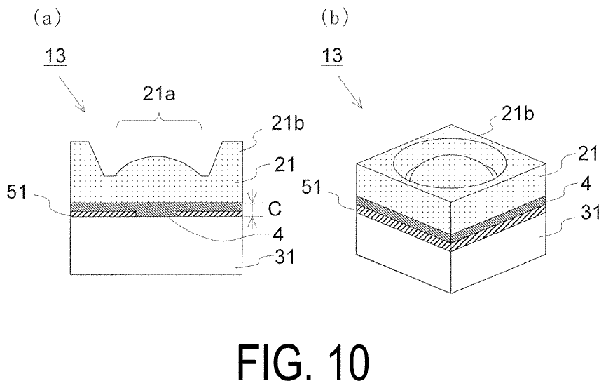

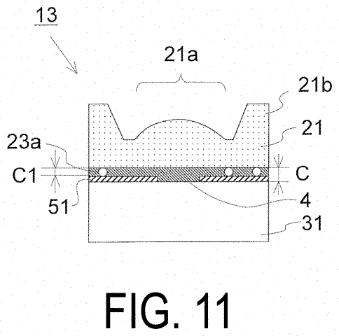

Through the manufacturing method, a hybrid lens of a fourth aspect is obtained, the hybrid lens thereof including the resin lens, the glass substrate, and an adhesive layer provided between the resin lens and the glass substrate. Note that in the present specification, the hybrid lens of the fourth aspect may be referred to as a “hybrid lens (C)”. An embodiment of a hybrid lens (C) obtained according to the first embodiment is illustrated in FIG. 10, and an embodiment of a hybrid lens (C) obtained according to the second embodiment is illustrated in FIG. 11. Also, FIG. 10(a) is a cross-sectional view of the hybrid lens (C), and FIG. 10(b) is an external view of the hybrid lens (C).

The hybrid lens (C) preferably has, in the non-effective region, a wall section that extends in the optical axis direction and is formed to surround the effective region from the side surface. In other words, the hybrid lens (C) preferably has an effective region in a recess formed in an upper surface of the resin lens (the surface of the side opposite the side at which the glass substrate is positioned). Additionally, the top portion of the wall section (the portion having the highest height in the optical axis direction) is preferably located at a position higher than the top portion of the effective region (a portion in the effective region having the highest height in the optical axis direction). With such a positional relationship, the effective region of the lens is less likely to be contacted and scratched during handling when the hybrid lens is being manufactured. Furthermore, the hybrid lens (C) can be adhered and fixed using the top portion of the wall section as an adherence point. Furthermore, the hybrid lens (C) can be integrally molded from the effective region to the wall section and thus excels in dimensional precision. As a result, focus adjustments are not required in fixing to the hybrid lens top portion and a lens fixing surface sensor or the like.

In the hybrid lens 13 illustrated in FIGS. 10 and 11, the resin lens body 21 includes, on the upper surface (the surface of the side opposite the side at which the glass substrate body 31 is positioned), the effective region 21a formed from a convex lens, the non-effective region 21b, and the wall, which is formed in the non-effective region 21b, extends in the optical axis direction, and is formed to surround the effective region 21a from the side surface. The wall section is formed along the peripheral edge of the resin lens body 21 in the hybrid lens 13. As illustrated in FIGS. 10 and 11, the top portion of the wall section is located at a position having a higher height in the optical axis direction than the top portion of the effective region 21a. The lower surface of the resin lens body 21 (the surface of the side at which the glass substrate body 31 is positioned) is planar.

In the hybrid lens 13 illustrated in FIGS. 10 and 11, the glass substrate 31 has a shape in which the upper surface (surface of the side at which the resin lens body 21 is positioned) and the lower surface (surface of the side opposite the side at which the resin lens body 21 is positioned) are planar shapes. The lower surface of the resin lens body 21 and the upper surface of the glass substrate body 31 are both planar and are mutually facing and parallel to each other. That is, the clearance C between the resin lens body 21 and the glass substrate body 31 is uniform throughout the direction perpendicular to the optical axis, and this state is maintained from before cutting.

In the hybrid lens 13 illustrated in FIGS. 10 and 11, a black layer 51 is provided between the resin lens body 21 and the glass substrate body 31, closer to the glass substrate body 31 side than the adhesive layer 4. The black layer 51 is partially provided on the surface of the glass substrate body 31 at a position overlapping the non-effective region 21b and the peripheral edge portion of the effective region 21a in the optical axis direction, and thus covers the non-effective region 21b and the peripheral edge portion of the effective region 21a of the resin lens body 21. The adhesive layer 4 joins the resin lens body 21 and the glass substrate body 31, and also joins the resin lens body 21 and the black layer 51.

In the hybrid lens 13 illustrated in FIG. 10, a butting part 21c is not present between the resin lens body 21 and the glass substrate body 31. This is because, in the lens array 1 prior to cutting, butting parts 21c are formed in the non-lens region, which is the region other than the region (lens region) that is singulated into individual lenses. In the hybrid lens 13 illustrated in FIG. 11, particles 23a are present between the resin lens body 21 and the glass substrate body 31. The resin lens body 21 and the glass substrate body 31 are fixed at positions at which the maximum particle size of this particle 23a is the same as the minimum thickness of the adhesive layer 4, and therefore the particles of the maximum particle size act as columns supporting the resin lens and the glass substrate, and the clearance C between the resin lens body 21 and the glass substrate body 31 is uniformly maintained prior to cutting of the lens array 10.

In a case where the lens region of the hybrid lens (C) has butting parts between the resin lens body and the glass substrate body, various concerns exist, such as (i) a connection surface is formed between the butting part and the resin lens or glass substrate, and thereby the adhering surface area between the resin lens and the glass substrate decreases, resulting in insufficient adhesive strength, (ii) cutting fluid used in cutting the lens array penetrates the connection surface and causes peeling to occur, and positioning adjustments between the resin lens and the glass substrate in the bonding become difficult, and (iii) the adhesive penetrates the connection surface due to capillary action, resulting in an increase in the thickness of the adhesive layer. In contrast, according to the manufacturing method, a hybrid lens (C) that does not have butting parts between the resin lens body and the glass substrate body can be manufactured as described above, and thus these concerns are dispelled.

Hybrid lenses (hybrid lenses (A) to (C)) according to an embodiment of the present disclosure can be used in various equipment provided with an imaging device, including, for example, a camera, a computer, a word processor, a printer, a copy machine, a facsimile machine, a telephone, a mobile device (personal digital assistant (PDA), such as a mobile phone, a smartphone, a gaming device, or a tablet), automotive equipment, building equipment, and astronomical equipment. In particular, a hybrid lens according to an embodiment of the present disclosure is useful as a lens for a small imaging device (lens with even higher precision), such as, for example, a compact camera (e.g., a mobile phone camera (a camera of a camera-equipped mobile phone), or a vehicle-mounted camera). The width (or diameter) of such a compact camera lens may be approximately 10 mm or less.

Each aspect disclosed in the present specification can be combined with any other feature disclosed herein. Note that each of the configurations, combinations thereof, or the like in each of the embodiments are examples, and additions, omissions, replacements, and other changes to the configurations may be made as appropriate without departing from the spirit of the present disclosure. In addition, each aspect of the invention according to the present disclosure is not limited by the embodiments or the following examples but is limited only by the claims.

### EXAMPLES

An embodiment of the present invention will be described in further detail below based on examples.

### EXAMPLES OF HYBRID LENS (A)

### Manufacturing Example A1

### Fabrication of Wafer-Level Lens Array

A mold having a two-dimensionally arranged lens cavity (in an array of 5 columns×5 rows) was coated with a one liquid part-type epoxy-based thermosetting composition (a mixture of 30 parts by mass of a silicone-based alicyclic epoxy resin, 15 parts by mass of a hydrogenated bisphenol A-type glycidyl ether, 55 parts by mass of an alicyclic epoxy compound, 0.2 parts by mass of a thermal acid generator, and 3 parts by mass of the other components) using a volumetric quantitative dispenser. Next, an upper die was superimposed on the mold coated with the curable composition and then subjected to a heating treatment (80° C.×1 minute, 170° C.×2 minutes, and 100° C.×1 minute) to cure the curable composition, and a wafer-level lens array was fabricated. The wafer-level lens array was treated for 1 hour in an oven at 200° C. for 1 hour under a nitrogen atmosphere, and was thereby fully cured and annealed. The glass transition temperature of the lens array after the annealing treatment was measured by DMA and determined to be 159° C.

### Manufacturing Example A2

### Formation of Chromium Oxide Film

One surface of a glass substrate (product name “D263 T eco”, available from Schott Japan Corporation) was partially patterned at positions overlapping a non-effective region and a peripheral edge portion of an effective region of a wafer-level lens array, and a film formed from chromium oxide was formed.

### Example A1

One surface (flat surface) of the resin lens array fabricated in Manufacturing Example A1 described above was coated with an ultraviolet light-curable adhesive (product name “UVA-400-9”, available from Resinous Corporation) using a volume-measuring dispenser (product name “MEASURING MASTER MPP-1 350PC Smart SM300QX”, available from Musashi Engineering, Inc.). Meanwhile, on the glass substrate on which the chromium oxide film was formed in Manufacturing Example A2 above, the center (effective region at which the film was not formed) of the surface on which the film was formed was also coated with the ultraviolet light-curable adhesive. An alignment mark on the wafer-level lens array coated with the adhesive and an alignment mark of the glass substrate were positionally aligned within an error of 5 μm or less, and the adhesive-coated surface of the wafer-level lens array and the film-formed surface of the glass substrate were bonded together, pressure bonded, and laminated. With this laminated state maintained, the laminated product was irradiated with ultraviolet rays of 3000 mJ/cm² at an illuminance of 100 mW/cm², and thereby the glass substrate and the wafer-level lens array were adhered and fixed, and a laminate was fabricated.

### Examples A2 to A4 and Comparative Examples A1 to A4

In each of Examples A2 to A4 and Comparative Examples A1 to A4, a laminate in which the glass substrate and the wafer-level lens array were adhered and fixed was fabricated in the same manner as in Example A1 with the exception that the commercially available product listed in Table 1 was used as the ultraviolet light-curable adhesive.

### Evaluation

The laminates fabricated in the examples and comparative examples were subjected to the following evaluation tests. Note that laminates in which peeling between the glass substrate and the lens was observed in the dicing evaluation were not subjected to a reflow evaluation.

### Glass Transition Temperature (DMA)

The glass transition temperature of the wafer-level lens array fabricated in Manufacturing Example A1 was measured using a dynamic mechanical analysis device (trade name “RSA-G2”, available from TA Instruments Japan Inc.) under conditions including a nitrogen atmosphere, a temperature increase rate of 5° C./min and a measurement temperature range of from 0 to 250° C. The temperature of the maximum value of tan δ in the obtained DMA curve was used as the glass transition temperature.

### Glass Transition Temperature (TMA)

The glass transition temperature of the adhesive layer fabricated in the examples and comparative examples was measured using a thermomechanical analyzer (product name “TMA SS7100”, available from Hitachi High-Tech Science Corporation). A pretreatment was first implemented (in which in a nitrogen atmosphere, the temperature was increased from 0° C. to 250° C. at a temperature increase rate of 5° C./min, and then decreased from 250° C. to 0° C. at a temperature decrease rate of −20° C./min), after which the glass transition temperature was measured in a nitrogen atmosphere in a measurement temperature range of from 0 to 250° C. at a temperature increase rate of 5° C./min. The temperature of the inflection point of the obtained TMA curve was then used as the glass transition temperature.

### Dicing Evaluation

Using a blade having a blade thickness of 0.09 mm, the laminates fabricated in the examples and comparative examples were diced and singulated into individual square pieces measuring 1.2 mm on each side with a thickness of 0.71 mm (glass thickness of 0.4 mm, lens thickness of 0.3 mm, and adhesive layer thickness of approximately 0.01 mm), and individual samples were thereby fabricated. The dicing was implemented using an automatic dicing saw (product name “DAD3350”, available from Disco Corporation) and dicing blades (product name “XD800-15GM415” and “54.0D-0.10T-40H” available from Tokyo Seimitsu Co., Ltd.) under conditions including a rotational speed of 15000 rpm and a machining speed of 0.5 mm/s. The appearance of the cut surface of the laminate after dicing, namely the presence or absence of shifting and peeling of the glass substrate and lens, was evaluated using a CNC image measurement system. If shifting and peeling were not observed, the dicing was determined to be good. The results are shown in Table 1.

### Reflow Evaluation

The individual sample fabricated in the dicing evaluation was placed in a reflow oven and heat treated under the following heating conditions. Subsequently, the individual sample was removed in a room temperature environment and allowed to cool, and the individual sample was then observed at a magnification of 500 to 700 times using a CNC image measurement system. Subsequently, the presence or absence of floating of the adhesive layer, peeling of the glass and resin lens, and yellowing of each layer were evaluated according to the following evaluation methods. The results are shown in Table 1. In the evaluation results shown in Table 1, if even one of five individual samples was evaluated as being poor, the example or comparative example thereof was determined to be poor. Note that Comparative Examples A2 and A3 exhibited peeling when diced and thus were not subjected to the reflow evaluation.

### Heating Conditions (Based on the Surface Temperature of the Individual Sample)

(1) Preheating: 60 to 120 seconds at a temperature of 150 to 190° C.

(2) Main heating after preheating: 60 to 150 seconds at 217° C. or more, maximum temperature of 260° C.

However, the temperature increase rate during the transition from preheating to main heating was controlled at a maximum of 3° C./sec.

### Method for Evaluating Peeling

Peeling: The sample was evaluated as being good in terms of peeling if no peeling was observed at the interface between the wafer-level lens and the adhesive layer and at the interface between the adhesive layer and the glass. If peeling was observed at the interfaces thereof, the sample was determined to be poor.

Floating of the adhesive layer: The sample was evaluated as being good in terms of floating of the adhesive layer if cracking and/or cohesive failure of the chromium oxide film was not observed, and was evaluated as being poor if such cracking and/or cohesive failure was observed.

### Method for Evaluating Thermal-Yellowing Resistance

The lens appearance after reflow was observed, and if no yellowing was found, the sample was evaluated as being good, and if yellowing was found, the sample was evaluated as being poor.

TABLE 1

| | | Comparative | Comparative | Comparative | | | | Comparative |
|---|---|---|---|---|---|---|---|---|
| | | Example A1 | Example A2 | Example A3 | Example A1 | Example A2 | Example A3 | Example A4 |
| Adhesive | | Adhesive A | U-401 | 8807L5 | UVA-400-9 | U-1455L | U-1455 | XVL-14L3KZ |
| Glass transition temperature | | 120 | 65 | 62.7 | 59 | 28.7 | 17 | −40 |
| [° C.] | | | | | | | | |
| Difference in glass transition | | 39 | 94 | 96.3 | 100 | 130.3 | 142 | 199 |
| temperature [° C.] | | | | | | | | |
| Dicing evaluation | | Good | Peeling | Peeling | Good | Good | Good | Positional |
| | | | | | | | | shifting of |
| | | | | | | | | about 3 mm |
| Reflow | Peeling | Good | — | — | Good | Good | Good | Good |
| evaluation | Floating of | Poor | — | — | Good | Good | Good | Good |
| | adhesive layer | | | | | | | |
| | Thermal-yellowing | Good | — | — | Good | Good | Good | — |
| | resistance | | | | | | | |

As is clear from Table 1, the hybrid lenses for which the glass transition temperature of the resin lens was higher than the glass transition temperature of the adhesive layer and the difference between the glass transition temperatures of the resin lens and the adhesive layer was from 97 to 150° C. did not experience floating of the adhesive layer or peeling of the glass and resin lens, even when exposed to a high temperature environment in the reflow evaluation. Also, yellowing of the hybrid lenses thereof was not observed after reflow. On the other hand, when the difference in glass transition temperatures was less than 97° C. (Comparative Examples A1 to A3), peeling occurred when dicing, and even if peeling did not occur when dicing, when such hybrid lens was exposed to a high temperature environment in the reflow evaluation, floating of the adhesive layer due to cohesive failure of the chromium oxide film was observed. In addition, in the case in which the difference in glass transition temperatures was greater than 150° C. (Comparative Example A4), shifting occurred during dicing.

The adhesives that were used in the examples and the comparative examples are as described below.

Adhesive A: A curable resin composition including 20 parts by mass of the product “PB3600” (available from Daicel Corporation), 20 parts by mass of the product “YX8000” (available from Mitsubishi Chemical Corporation), 30 parts by mass of the product “Celloxide 8010” (available from Daicel Corporation), 15 parts by mass of the product “Celvenus M0108” (available from Daicel Corporation), 15 parts by mass of the product “OXT-221” (available from Toagosei Co., Ltd.), and 2 parts by mass of the product “CPI-210S” (available from San-Apro Ltd.).

U-401: A modified acrylic-based adhesive of the product name “U-401” available from Chemitech Inc.

8807L5: A modified acrylic-based adhesive of the product name “WORLD ROCK 8807L5” available from Kyoritsu Chemical & Co., Ltd.

UVA-400-9: An epoxy-based adhesive of the product name “UVA-400-9”, available from Resinous Corporation.

U-1455 L: A modified acrylic-based adhesive of the product name “U-1455L” available from Chemitech Inc.

U-1455: A modified acrylic-based adhesive of the product name “U-1455” available from Chemitech Inc.

XVL-14L3KZ: A modified acrylic-based adhesive of the product name “WORLD ROCK XVL-14L3KZ” available from Kyoritsu Chemical & Co., Ltd.

### Examples of Hybrid Lens (B)

### Manufacturing Example B1

### Fabrication of Wafer-level Lens Array

A mold having a two-dimensionally arranged lens cavity (in an array of 5 columns×5 rows) was coated with a one liquid part-type epoxy-based thermosetting composition (a mixture of 30 parts by mass of a silicone-based alicyclic epoxy resin, 15 parts by mass of a hydrogenated bisphenol A-type glycidyl ether, 55 parts by mass of an alicyclic epoxy compound, 0.2 parts by mass of a thermal acid generator, and 3 parts by mass of the other components) using a volumetric quantitative dispenser. Next, an upper die was superimposed on the mold coated with the curable composition and then subjected to a heating treatment (80° C.×1 minute, 170° C.×2 minutes, and 100° C.×1 minute) to cure the curable composition, and a wafer-level lens array was fabricated. The wafer-level lens array was treated for 1 hour in an oven at 200° C. for 1 hour under a nitrogen atmosphere, and was thereby fully cured and annealed.

### Manufacturing Example B2

### Formation of Light-Shielding Portion

A chromium oxide film was formed through vapor deposition on one surface of a glass substrate (product name “D263 T eco”, available from Schott Japan Corporation) at positions overlapping a non-effective region and a peripheral edge portion of an effective region of a wafer-level lens array, after which partial patterning was implemented by removing, through etching, the chromium oxide film at regions becoming light-transmitting portions, and a light-shielding portion made of the chromium oxide film was formed.

### Example B1

One surface (flat surface) of the resin lens array fabricated in Manufacturing Example B1 described above was coated with an ultraviolet light-curable adhesive (product name “UVA-400-9”, available from Resinous Corporation) using a volume-measuring dispenser (product name “MEASURING MASTER MPP-1 350PC Smart SM300QX”, available from Musashi Engineering, Inc.). Meanwhile, on the glass substrate on which the light-shielding portion was formed in Manufacturing Example B2 above, the center (effective region at which the light-shielding portion was not formed) of the surface on which the light-shielding portion was formed was also coated with the ultraviolet light-curable adhesive. An alignment mark on the wafer-level lens array coated with the adhesive and an alignment mark of the glass substrate were positionally aligned within an error of 5 μm or less, and the adhesive-coated surface of the wafer-level lens array and the film-formed surface of the glass substrate were bonded together, pressure bonded, and laminated. With this laminated state maintained, the laminated product was irradiated with ultraviolet rays of 3000 mJ/cm² at an illuminance of 100 mW/cm², and thereby the glass substrate and the wafer-level lens array were adhered and fixed, and a laminate was fabricated.

### Examples B2 to B5

In each of Examples B2 to B5, a laminate in which the glass substrate and the wafer-level lens array were adhered and fixed was fabricated in the same manner as in Example B1 with the exception that the commercially available product listed in Table 2 was used as the ultraviolet light-curable adhesive.

### Evaluation

The laminates fabricated in the examples were subjected to the following evaluation tests. Note that laminates in which peeling between the glass substrate and the lens was observed in the dicing evaluation were not subjected to a reflow evaluation. The results are shown in Table 2. Note that the symbol “-” in the table indicates that evaluation was not performed.

### Refractive Index and Reflectivity

First, the top of a slide glass (product name “S1112”, available from Matsunami Glass Ind., Ltd.) was treated with a baking-type mold release agent (product name “KS-700”, available from Shin-Etsu Chemical Co., Ltd.), and a mold was fabricated with a thickness of 0.5 mm. The ultraviolet light-curable adhesive produced in the examples was injected into the above-described mold and then irradiated with ultraviolet rays at 3000 mJ/cm² (illuminance: 100 mW/cm², irradiation time: 30 sec) using a UV-LED irradiation device (product name “UV-MODULE”, model: U365W-979, available from Ushio, Inc.), and the adhesive layer was cured. The adhesive layer was removed from the mold. A prism coupler (model “Model 2010/M”, available from Metricon Corporation) was then used to measure the refractive index of each of the glass substrate, the resin lens, and the adhesive layer fabricated above. The reflectivity was then calculated from the following equation using the refractive indexes (n1, n2) of two materials forming an interface.

Reflectivity R[%]={(n2−n1)/(n2+n1)}²

### Dicing Evaluation

Using a blade having a blade thickness of 0.09 mm, the laminates fabricated in the examples and comparative examples were diced and singulated into individual square pieces measuring 1.2 mm on each side with a thickness of 0.71 mm (glass thickness of 0.4 mm, lens thickness of 0.3 mm, and adhesive layer thickness of approximately 0.01 mm), and individual samples were thereby fabricated. The dicing was implemented using an automatic dicing saw (product name “DAD3350”, available from Disco Corporation) and dicing blades (product name “XD800-15GM415” and “54.0D-0.10T-40H” available from Tokyo Seimitsu Co., Ltd.) under conditions including a rotational speed of 15000 rpm and a machining speed of 0.5 mm/s. The appearance of the cut surface of the laminate after dicing, namely the presence or absence of shifting and peeling of the glass substrate and lens, was evaluated using a CNC image measurement system. Samples having shifting of 4 μm or less or in which no shifting was observed were evaluated as being good.

### Reflow Evaluation

The individual sample fabricated in the dicing evaluation was placed in a reflow oven and heat treated under the following heating conditions. Subsequently, the individual sample was removed in a room temperature environment and allowed to cool, and the individual sample was then observed at a magnification of 500 to 700 times using a CNC image measurement system. Then, the presence or absence of peeling of the glass and resin lens, and yellowing of each layer was evaluated according to the following evaluation method.

### Heating Conditions (Based on the Surface Temperature of the Individual Sample)

(1) Preheating: 60 to 120 seconds at a temperature of 150 to 190° C.

(2) Main heating after preheating: 60 to 150 seconds at 217° C. or more, maximum temperature of 260° C.

However, the temperature increase rate during the transition from preheating to main heating was controlled at a maximum of 3° C./sec.

### Method for Evaluating Peeling

Peeling: The sample was evaluated as being good in terms of peeling if no peeling was observed at the interface between the wafer-level lens and the adhesive layer and at the interface between the adhesive layer and the glass. If peeling was observed at the interfaces thereof, the sample was determined to be poor.

### Method for Evaluating Thermal-Yellowing Resistance

The lens appearance after reflow was observed and evaluated with regard to whether yellowing was observed.

TABLE 2

| | | Example B1 | Example B2 | Example B3 | Example B4 | Example B5 |
|---|---|---|---|---|---|---|
| Adhesive | | UVA-400-9 | U-1455L | U-1455 | Adhesive A | XVL-14L3KZ |
| Dicing evaluation | | Good | Good | Good | Good | Good |
| Reflow | Peeling | Good | Good | Good | Good | Good |
| evaluation | Thermal-yellowing resistance | Good | Good | Good | Good | — |
| Refractive | Glass substrate | 1.5230 | 1.5230 | 1.5230 | 1.5230 | 1.5230 |
| index | Adhesive layer | 1.5130 | 1.5030 | 1.4999 | 1.5219 | 1.5230 |
| | Resin lens | 1.5084 | 1.5084 | 1.5084 | 1.5084 | 1.5084 |
| Difference in | Glass substrate/adhesive layer | 0.0100 | 0.0200 | 0.0232 | 0.0011 | 0.0000 |
| refractive index | Adhesive layer/resin lens | 0.0046 | 0.0054 | 0.0086 | 0.0135 | 0.0146 |
| Reflectance | Glass substrate/adhesive layer | 0.001 | 0.004 | 0.006 | 0.000 | 0.000 |
| [%] | interface | | | | | |
| | Adhesive layer/resin lens | 0.000 | 0.000 | 0.001 | 0.002 | 0.002 |
| | interface | | | | | |

As is clear from Table 2, hybrid lenses in which a metal compound layer was used as the light-shielding portion and the resin lens and the glass substrate were bonded to each other through an adhesive layer were easily produced with shifting of 4 μm or less or no observed shifting, and the hybrid lenses thereof could be diced with good precision from the lens array laminate. In addition, even when the hybrid lenses thereof were exposed to a high temperature environment in the reflow evaluation, peeling of the glass and resin lens did not occur. Also, yellowing of the hybrid lenses thereof was not observed after reflow.

The adhesives that were used in the examples and the comparative examples are as described below.

UVA-400-9: An epoxy-based adhesive of the product name “UVA-400-9”, available from Resinous Corporation.

U-1455 L: A modified acrylic-based adhesive of the product name “U-1455L” available from Chemitech Inc.

U-1455: A modified acrylic-based adhesive of the product name “U-1455” available from Chemitech Inc.

Adhesive A: A curable resin composition including 20 parts by mass of the product “PB3600” (available from Daicel Corporation), 20 parts by mass of the product “YX8000” (available from Mitsubishi Chemical Corporation), 30 parts by mass of the product “Celloxide 8010” (available from Daicel Corporation), 15 parts by mass of the product “Celvenus M0108” (available from Daicel Corporation), 15 parts by mass of the product “OXT-221” (available from Toagosei Co., Ltd.), and 2 parts by mass of the product “CPI-210S” (available from San-Apro Ltd.).

XVL-14L3KZ: A modified acrylic-based adhesive of the product name “WORLD ROCK XVL-14L3KZ” available from Kyoritsu Chemical & Co., Ltd.

Hereinafter, variations of the invention according to the present disclosure will be described.

[Appendix A1] A hybrid lens including:

a glass substrate;

a resin lens provided on at least one surface of the glass substrate, and an adhesive layer provided between the glass substrate and the resin lens,

wherein

the glass transition temperature of the resin lens is higher than the glass transition temperature of the adhesive layer, and

a difference between the glass transition temperature of the resin lens and the glass transition temperature of the adhesive layer is from 97 to 150° C. (preferably from 98 to 130° C., and more preferably from 99 to 120° C.).

[Appendix A2] The hybrid lens according to Appendix A1, wherein the glass transition temperature of the resin lens is 140° C. or more (preferably 150° C. or more).

[Appendix A3] The hybrid lens according to Appendix A1 or A2, wherein the glass transition temperature of the resin lens is 200° C. or less (preferably 190° C. or less).

[Appendix A4] The hybrid lens according to any one of Appendices A1 to A3, wherein the glass transition temperature of the adhesive layer is 62° C. or less (preferably 60° C. or less).

[Appendix A5] The hybrid lens according to any one of Appendices A1 to A4, wherein the glass transition temperature of the adhesive layer is 30° C. or more (preferably 35° C. or more).

[Appendix A6] The hybrid lens according to any one of Appendices A1 to A5, wherein the adhesive layer is a curable adhesive layer (preferably a photocurable adhesive layer).

[Appendix A7] The hybrid lens according to any one of Appendices A1 to A6, wherein the adhesive layer includes an epoxy-based resin and/or an acrylic-based resin.

[Appendix A8] The hybrid lens according to Appendix A7, wherein the adhesive layer includes an epoxy-based resin.

[Appendix A9] The hybrid lens according to Appendix A8, wherein the epoxy-based resin contains a constituent unit derived from an alicyclic epoxy compound (preferably a compound having an alicyclic ring and a glycidyl ether group in the molecule).

[Appendix A10] The hybrid lens according to Appendix A9, wherein the epoxy-based resin further includes a constituent unit derived from an oxetane compound.

[Appendix A11] The hybrid lens according to any one of Appendices A1 to A10, wherein the resin lens includes an epoxy-based resin.

[Appendix A12] The hybrid lens according to Appendix A11, wherein the epoxy-based resin includes a constituent unit derived from an alicyclic epoxy compound (preferably a compound having an alicyclic epoxy group and a compound having an alicyclic ring and a glycidyl ether group in the molecule).

[Appendix A13] The hybrid lens according to Appendix A12, wherein the compound having an alicyclic epoxy group includes a compound represented by Formula (i) and an epoxy-modified siloxane.

[Appendix A14] The hybrid lens according to Appendix A12 or A13, wherein the epoxy-based resin further includes a constituent unit derived from an oxetane compound.

[Appendix A15] The hybrid lens according to any one of Appendices A1 to A14, wherein the adhesive layer joins the resin lens and the glass substrate.

[Appendix A16] The hybrid lens according to any one of Appendices A1 to A15, wherein the resin lens has a convex lens shape in an effective region.

[Appendix A17] The hybrid lens according to Appendix A16, wherein a surface of the resin lens of a side opposite the surface having the convex lens shape in the effective region is a planar shape.

[Appendix A18] The hybrid lens according to any one of Appendices A1 to A18, wherein the resin lens includes a wall section extending in an optical axis direction and formed to surround the effective region.

[Appendix A19] The hybrid lens according to Appendix A18, wherein a top portion of the wall section is located at a position higher than a top portion of the convex lens shape in the optical axis direction.

[Appendix A20] The hybrid lens according to any one of Appendices A1 to A19, wherein the glass substrate does not have an effective region.

[Appendix A21] The hybrid lens according to any one of Appendices A1 to A20, wherein the surface of the resin lens side of the glass substrate is a planar shape.

[Appendix A22] The hybrid lens according to any one of Appendices A1 to A21, wherein the surface of the glass substrate side of the resin lens and the surface of the resin lens side of the glass substrate are both planar shaped and are mutually facing and parallel.

[Appendix A23] The hybrid lens according to any one of Appendices A1 to A22, wherein a black layer is provided between the glass substrate and the adhesive layer.

[Appendix A24] The hybrid lens according to Appendix A23, wherein the black layer includes a metal compound (metal oxide, chromium compound, or chromium oxide).

[Appendix A25] The hybrid lens according to Appendix A23 or A24, wherein the adhesive layer joins the black layer and the resin lens.

[Appendix A26] The hybrid lens according to any one of Appendices A23 to A25, wherein the black layer is partially disposed not to completely blocking an optical path.

[Appendix A27] The hybrid lens according to any one of Appendices A23 to A26, wherein the black layer is disposed at a position covering a non-effective region of the resin lens.

[Appendix A28] The hybrid lens according to Appendix A27, wherein the black layer is disposed to extend to a position covering a peripheral edge portion of the effective region.

[Appendix A29] The hybrid lens according to any one of Appendices A23 to A28, wherein the black layer is a light-shielding member or a diaphragm.

[Appendix A30] The hybrid lens according to any one of Appendices A23 to A29, wherein the black layer is positioned on the glass substrate side in relation to the adhesive layer (is preferably formed on the glass substrate surface).

[Appendix A31] The hybrid lens according to any one of Appendices A1 to A30, further including an anti-reflective film on the glass substrate surface and/or the resin lens surface.

[Appendix A32] The hybrid lens according to any one of Appendices A1 to A31, wherein the hybrid lens is an optical lens (preferably an imaging lens).

[Appendix A33] The hybrid lens according to any one of Appendices A1 to A32, wherein the hybrid lens is a lens array having a configuration in which two or more effective regions are arranged two-dimensionally, and the two or more effective regions are linked to each other through a joining part (preferably a non-effective region).

[Appendix A34] The hybrid lens according to any one of Appendices A1 to A32, having only one effective region in a direction perpendicular to the optical axis.

Hereinafter, further variations of the invention according to the present disclosure will be described.

[Appendix B1] A hybrid lens including a glass substrate;

a resin lens provided on at least one surface of the glass substrate;

an adhesive layer provided between the glass substrate and the resin lens; and

a metal compound layer provided between the glass substrate and the resin lens.

[Appendix B2] The hybrid lens according to Appendix B1, wherein the metal compound layer is a black layer.

[Appendix B3] The hybrid lens according to Appendix B1 or B2, wherein the metal compound layer includes a metal oxide.

[Appendix B4] The hybrid lens according to any one of Appendices B1 to B3, wherein the metal compound layer includes a chromium compound.

[Appendix B5] The hybrid lens according to any one of Appendices B1 to B4, wherein a difference in refractive indexes between the glass substrate and the adhesive layer and/or a difference in refractive indexes between the resin lens and the adhesive layer is 0.1 or less (preferably 0.08 or less, and more preferably 0.05 or less).

[Appendix B6] The hybrid lens according to any one of Appendices B1 to B5, wherein a reflectance of an interface between the resin lens and the adhesive layer is 0.5% or less (preferably 0.1% or less, more preferably 0.05% or less, and even more preferably 0.01% or less).

[Appendix B7] The hybrid lens according to any one of Appendices B1 to B6, wherein the reflectance at an interface between the glass substrate and the adhesive layer is 0.5% or less (preferably, 0.1% or less, more preferably 0.05% or less, and even more preferably 0.01% or less).

[Appendix B8] The hybrid lens according to any one of Appendices B1 to B7, wherein the adhesive layer is a photocurable adhesive layer.

[Appendix B9] The hybrid lens according to any one of Appendices B1 to B8, wherein the adhesive layer includes an epoxy-based resin and/or an acrylic-based resin.

[Appendix B10] The hybrid lens according to Appendix B9, wherein the adhesive layer includes an epoxy-based resin.

[Appendix B11] The hybrid lens according to any one of Appendices B1 to B10, wherein the adhesive layer joins the metal compound layer and the resin lens.

[Appendix B12] The hybrid lens according to any one of Appendices B1 to B11, wherein the metal compound layer is provided on a surface of the glass substrate.

[Appendix B13] The hybrid lens according to any one of Appendices B1 to B12, wherein the resin lens has a convex lens shape in an effective region.

[Appendix B14] The hybrid lens according to any one of Appendices B1 to B13, wherein the resin lens includes a wall section extending in an optical axis direction and formed to surround the effective region.

[Appendix B15] The hybrid lens according to Appendix B14, wherein a top portion of the wall section is located at a position higher than a top portion of the convex lens shape in the optical axis direction.

[Appendix B16] The hybrid lens according to any one of Appendices B1 to B15, further including an anti-reflective film on the glass substrate surface and/or the resin lens surface.

Hereinafter, further variations of the invention according to the present disclosure will be described.

[Appendix C1] A method for manufacturing a hybrid lens, the method including singulating a lens array into individual hybrid lenses, the lens array including a glass substrate, a resin lens provided on at least one surface of the glass substrate, and an adhesive layer provided between the glass substrate and the resin lens, and the lens array satisfying a requirement (1) or (2):

(1) In a region of the lens array other than a region that is singulated into the individual hybrid lenses, the lens array includes, in the adhesive layer, a plurality (preferably 3 or more, more preferably 4 or more) of butting parts that connect the resin lens and glass substrate mutually facing;

(2) The adhesive layer contains particles, and a maximum particle size of the particles is the same as a minimum thickness of the adhesive layer.

[Appendix C2] The method according to Appendix C1, wherein, in the requirement (2), the particles are transparent particles.

[Appendix C3] The method according to Appendix C1 or C2, wherein in the requirement (1), the butting parts are positioned closer to an outer edge side in the lens array than an aggregated region in which individual regions that each become the individual hybrid lens are aggregated.

[Appendix C4] The method according to any one of Appendices C1 to C3, wherein the butting parts are not formed between regions that are singulated into the individual hybrid lenses.

[Appendix C5] The method according to any one of Appendices C1 to C4, wherein in the requirement (1), the butting parts are integrally formed with a resin lens body.

[Appendix C6] The method according to any one of Appendices C1 to C5, further including, prior to the singulating, bonding together the resin lens and the glass substrate to obtain a laminate.

[Appendix C7] The method according to Appendix C6, wherein in the bonding, a bonding surface of the resin lens is coated with an adhesive (preferably a one liquid-part type curable composition, more preferably a one liquid-part type photocurable composition), which forms the adhesive layer.

[Appendix C8] The method according to Appendix C6 or C7, wherein in the bonding, the butting parts are formed on the bonding surface of the resin lens.

[Appendix C9] The method according to any one of Appendices C6 to C8, wherein in the bonding, a bonding surface of the glass substrate is coated with an adhesive (preferably a one liquid-part type curable composition, more preferably a one liquid-part type photocurable composition), which forms the adhesive layer.

[Appendix C10] The method according to any one of Appendices C6 to C9, wherein in the bonding, both the bonding surface of the resin lens and the bonding surface of the glass substrate are coated with an adhesive (preferably a one liquid-part type curable composition, more preferably a one liquid-part type photocurable composition), which forms the adhesive layer.

[Appendix C11] The method according to Appendix C10, wherein the adhesive is applied to the resin lens or the glass substrate (in particular, one for which the lens region is planar) at a coating amount of 90 vol % or more (preferably 95 vol % or more) relative to the total amount of the applied adhesive, and is applied to the other of the resin lens or the glass substrate at a coating amount of 10 vol % or less (preferably 5 vol % or less) relative to the total amount of the applied adhesive.

[Appendix C12] The method according to any one of Appendices C6 to C11, wherein in the bonding, a black layer is provided on a bonding surface of the glass substrate (preferably the surface of the glass substrate body).

[Appendix C13] The method according to Appendix C12, wherein at least a portion of a region where the black layer is not provided is coated with the adhesive, which forms the adhesive layer.

[Appendix C14] The method according to any one of Appendices C1 to C13, wherein the hybrid lens includes the black layer between the glass substrate and the resin lens (preferably, between the glass substrate and the adhesive layer).

[Appendix C15] The method according to Appendix C14, wherein the adhesive layer joins the black layer and a resin lens body.

[Appendix C16] The method according to Appendix C14 or C15, wherein the black layer is disposed at a position covering, of the resin lens, a non-effective region that does not effectively exhibit functions as a lens in a state in which the resin lens and the glass substrate are laminated (preferably, the black layer is disposed extending to a position covering a peripheral edge portion of an effective region that effectively exhibits functions as a lens).

[Appendix C17] The method according to any one of Appendices C6 to C16, further including curing (preferably photo-curing) the adhesive on the laminate fabricated by the bonding to form an adhesive layer.

[Appendix C18] The method according to Appendix C17, wherein the singulating is performed after the curing of the adhesive.

[Appendix C19] The method according to any one of Appendices C1 to C18, wherein the lens array satisfies the requirement (1).

[Appendix C20] The method according to any one of Appendices C1 to C19, wherein the lens array satisfies the requirement (2).

[Appendix C21] The method according to any one of Appendices C1 to C20, wherein the resin lens is a lens array in which a plurality of effective regions that effectively exhibit a function as a lens are aligned and coupled in a direction perpendicular to the optical axis.

[Appendix C22] The method according to Appendix C21, wherein the lens array includes the effective regions and non-effective regions that do not effectively exhibit functions as a lens, the effective regions and non-effective regions being alternately arranged in a direction perpendicular to the optical axis.

[Appendix C23] The method according to Appendix C22, wherein the lens array has recesses and protrusions alternating in a direction perpendicular to the optical axis and has the effective regions (preferably a convex lens shape) inside the recesses, and the protrusions are the non-effective regions.

[Appendix C24] The method according to Appendix C22 or C23, wherein the effective region has a convex lens shape, and a height of a top portion of the convex lens is lower than a height of a protrusion in the non-effective region.

[Appendix C25] The method according to any one of Appendices C21 to C24, wherein the surface (bonding surface) of the resin lens of the side opposite the effective region is a planar shape.

[Appendix C26] The method according to any one of Appendices C1 to C25, wherein the hybrid lens includes an anti-reflective film on the glass substrate surface and/or the resin lens surface.

[Appendix C27] A hybrid lens including:

a glass substrate;

a resin lens provided on at least one surface of the glass substrate; and

an adhesive layer provided between the glass substrate and the resin lens,

the adhesive layer including particles, and a maximum particle size of the particles being the same as a minimum thickness of the adhesive layer.

[Appendix C28] The hybrid lens according to Appendix C27, wherein the particles are transparent particles.

[Appendix C29] The hybrid lens according to Appendix C27 or C28, wherein a black layer is provided between the glass substrate and the resin lens (preferably, between the glass substrate and the adhesive layer).

[Appendix C30] The hybrid lens according to Appendix C29, wherein the adhesive layer joins the black layer and the resin lens.

[Appendix C31] The hybrid lens according to any one of C27 to C30, wherein the hybrid lens includes an effective region that effectively exhibits functions as a lens and a non-effective region that does not effectively exhibit functions as a lens, and the hybrid lens includes, in the non-effective region, a wall section extending in the optical axis direction and formed to surround the effective region from the side surface.

[Appendix C32] The hybrid lens according to Appendix C31, wherein the top portion of the wall section is located at a position higher than a top portion of the effective region.

[Appendix C33] The hybrid lens according to any one of Appendices C27 to C32, further including an anti-reflective film on the glass substrate surface and/or the resin lens surface.

### REFERENCE SIGNS LIST

10 Lens array
11, 12, 13 Hybrid lens
2 Resin lens
21 Resin lens body
21a Effective region (convex lens)
21b Non-effective region
21c Butting part
22 Wall section
23 Adhesive
23a Particle
3 Glass substrate
31 Glass substrate body
4 Adhesive layer
51 Black layer
52 Metal oxide layer
R1 Lens region
R2 Aggregated region
R3 Non-lens region

1. A hybrid lens comprising:
a glass substrate;
a resin lens provided on at least one surface of the glass substrate; and
an adhesive layer provided between the glass substrate and the resin lens,
wherein
a glass transition temperature of the resin lens is higher than a glass transition temperature of the adhesive layer, and
a difference between the glass transition temperature of the resin lens and the glass transition temperature of the adhesive layer is from 97 to 150° C.

2. The hybrid lens according to claim 1, wherein the glass transition temperature of the resin lens is 140° C. or more.

3. The hybrid lens according to claim 1, wherein the glass transition temperature of the adhesive layer is 60° C. or less.

4. The hybrid lens according to claim 1, wherein the adhesive layer is a photocurable adhesive layer.

5. The hybrid lens according to claim 1, wherein the adhesive layer comprises an epoxy-based resin and/or an acrylic-based resin.

6. The hybrid lens according to claim 5, wherein the adhesive layer comprises an epoxy-based resin.

7. The hybrid lens according to claim 6, wherein the epoxy-based resin comprises a constituent unit derived from an alicyclic epoxy compound.

8. The hybrid lens according to claim 1, wherein the resin lens comprises an epoxy-based resin.

9. The hybrid lens according to claim 8, wherein the epoxy-based resin comprises a constituent unit derived from an alicyclic epoxy compound.

10. The hybrid lens according to claim 1, wherein a black layer is provided between the glass substrate and the adhesive layer.

11. The hybrid lens according to claim 10, wherein the black layer comprises a metal compound.

12. The hybrid lens according to claim 10, wherein the adhesive layer joins the black layer and the resin lens.

13. The hybrid lens according to claim 1, wherein the resin lens has a convex lens shape in an effective region.

14. The hybrid lens according to claim 1, wherein the resin lens comprises a wall section extending in an optical axis direction and formed to surround an effective region.

15. The hybrid lens according to claim 14, wherein a top portion of the wall section is located at a position higher than a top portion of the convex lens shape in the optical axis direction.

16. A method for manufacturing a hybrid lens, the method comprising singulating a lens array into individual hybrid lenses, the lens array comprising a glass substrate, a resin lens provided on at least one surface of the glass substrate, and an adhesive layer provided between the glass substrate and the resin lens, and the lens array satisfying a requirement (1) or (2):
(1) in a region of the lens array other than a region that is singulated into the individual hybrid lenses, the lens array comprises, in the adhesive layer, a plurality of butting parts that connect the resin lens and the glass substrate mutually facing;
(2) the adhesive layer contains particles, and a maximum particle size of the particles is the same as a minimum thickness of the adhesive layer.

17. The method according to claim 16, wherein, in the requirement (2), the particles are transparent particles.

18. The method according to claim 16, wherein, in the requirement (1), the butting parts are positioned closer to an outer edge side in the lens array than an aggregated region in which individual regions that each become the individual hybrid lens are aggregated.

19. The method according to claim 16, wherein in the requirement (1), the butting parts are integrally formed with a resin lens body.

20. The method according to claim 16, further comprising, prior to the singulating, bonding together the resin lens and the glass substrate to obtain a laminate, wherein a bonding surface of the resin lens is coated with an adhesive, which forms the adhesive layer.

21. The method according to claim 20, wherein in the bonding, the butting parts are formed on the bonding surface of the resin lens.

22. The method according to claim 20, wherein in the bonding, a bonding surface of the glass substrate is coated with the adhesive, which forms the adhesive layer.

23. The method according to claim 20, wherein in the bonding, a black layer is provided on a bonding surface of the glass substrate.

24. The method according to claim 23, wherein in the bonding, the black layer is partially provided on the bonding surface of the glass substrate, and at least a portion of a region where the black layer is not provided is coated with an adhesive, which forms the adhesive layer.

25. The method according to claim 23, wherein the adhesive layer joins the black layer and a resin lens body.

26. The method according to claim 20, further comprising curing the adhesive on the laminate fabricated by the bonding to form the adhesive layer.

27. The method according to claim 26, wherein the singulating is performed after the curing of the adhesive.

28. The method according to claim 20, wherein the lens array satisfies the requirement (1).

29. The method according to claim 20, wherein the lens array satisfies the requirement (2).

30. A hybrid lens comprising:
a glass substrate;
a resin lens provided on at least one surface of the glass substrate; and
an adhesive layer provided between the glass substrate and the resin lens,
wherein
the adhesive layer comprises particles, and a maximum particle size of the particles is the same as a minimum thickness of the adhesive layer.

31. The hybrid lens according to claim 30, wherein the particles are transparent particles.

32. The hybrid lens according to claim 30, wherein a black layer is provided between the glass substrate and the adhesive layer.

33. The hybrid lens according to claim 32, wherein the adhesive layer joins the black layer and the resin lens.

34. A hybrid lens comprising:
a glass substrate;
a resin lens provided on at least one surface of the glass substrate;
an adhesive layer provided between the glass substrate and the resin lens; and
a metal compound layer provided between the glass substrate and the resin lens.

35. The hybrid lens according to claim 34, wherein the metal compound layer is a black layer.

36. The hybrid lens according to claim 34, wherein the metal compound layer comprises a metal oxide.

37. The hybrid lens according to claim 34, wherein the metal compound layer comprises a chromium compound.

38. The hybrid lens according to claim 34, wherein a difference in refractive indexes between the glass substrate and the adhesive layer and/or a difference in refractive indexes between the resin lens and the adhesive layer is 0.1 or less.

39. The hybrid lens according to claim 34, wherein the adhesive layer is a photocurable adhesive layer.

40. The hybrid lens according to claim 34, wherein the adhesive layer comprises an epoxy-based resin and/or an acrylic-based resin.

41. The hybrid lens according to claim 34, wherein the adhesive layer comprises an epoxy-based resin.

42. The hybrid lens according to claim 34, wherein the adhesive layer joins the metal compound layer and the resin lens.

43. The hybrid lens according to claim 34, wherein the metal compound layer is provided on a surface of the glass substrate.

44. The hybrid lens according to claim 34, wherein the resin lens has a convex lens shape in an effective region.

45. The hybrid lens according to claim 34, wherein the resin lens comprises a wall section extending in an optical axis direction and formed to surround an effective region.

46. The hybrid lens according to claim 45, wherein a top portion of the wall section is located at a position higher than a top portion of the convex lens shape in the optical axis direction.
